(19) United States
(12) Patent Application Publication
(10) Pub. No.: US 2013/0209985 A1
(43) Pub. Date: Aug. 15, 2013

(54) SAMPLE COLLECTION DEVICES WITH BLOOD STABILIZING AGENTS

(71) Applicants: Randal A. Hoke, Cary, NC (US); Justyna M. Dudaronek, Morristown, NJ (US); Keith A. Moskowitz, Monroe, NY (US); Frank Sinquett, Vauxhall, NJ (US)

(72) Inventors: Randal A. Hoke, Cary, NC (US); Justyna M. Dudaronek, Morristown, NJ (US); Keith A. Moskowitz, Monroe, NY (US); Frank Sinquett, Vauxhall, NJ (US)

(21) Appl. No.: 13/757,080

(22) Filed: Feb. 1, 2013

Related U.S. Application Data
(60) Provisional application No. 61/594,152, filed on Feb. 2, 2012.

(51) Int. Cl. A01N 1/02

(52) U.S. Cl. CPC A01N 1/0226
USPC 435/2; 435/307.1

(57) ABSTRACT

Disclosed are devices for collecting and stabilizing blood or plasma and which contain an anti-coagulant, an antiplatelet agent, and a solubilization agent, and which may optionally include at least one other blood stabilization agent. Methods of making and using the devices in clinical medicine are also provided.

### CROSS-REFERENCE TO RELATED APPLICATIONS

The present application claims the benefit of the filing date of U.S. Provisional Patent Application No. 61/594,152, filed Feb. 2, 2012, the disclosure of which is hereby incorporated herein by reference.

### BACKGROUND OF THE INVENTION

### Description of Related Art

Ethylenediamine tetraacetic acid (EDTA) is a polyprotic acid containing four carboxylic acid groups and two amine groups with lone-pair electrons that chelate calcium and several other metal ions. EDTA has been long recommended as the anticoagulant of choice in the field of blood collection and clinical hematology, based on its ability to preserve cells, and thus ensure accuracy of clinical hematological tests such as complete blood count (CBC) and peripheral blood smears. Calcium is necessary for a wide range of enzyme reactions of the coagulation cascade. Removal of calcium from collected blood is essential for purposes of preventing blood clotting during storage of the blood in the collection device, which interferes with the subsequent hematology testing.

The remarkable expansion in laboratory test volume and complexity has amplified the potential spectrum of applications for this anticoagulant, including a variety of innovative tests in the field of plasma proteomics research, such as its use in measuring cytokines, protein and peptides, and other markers of cardiac disease. The chelating action of EDTA is advantageous here because the activity of many proteases requires metals. Consequently, EDTA is the anticoagulant of choice for collection and storage of molecules that are susceptible to high degree of enzymatic degradation in vitro. Some molecules cannot be efficiently stabilized by EDTA alone and thus require addition of other antiproteolytic substances such as protease inhibitors. See, e.g., U.S. Pat. No. 7,309,468.

However, use of EDTA might be greatly hampered by changes in blood cells that may be induced by this anticoagulant. For example, exposure of platelets to EDTA can result in distortion of their morphology, including shape change and formation of agglutinates, rendering EDTA unsuitable for measurements of platelet activation as part of the full blood profile and for functional assays on platelets. An additional problem is the potential development of pseudothrombocytopenia in EDTA-anticoagulated specimens, typically characterized by low platelet counts due to platelet clumping or adhesion to white blood cells. Pseudothrombocytopenia can complicate obtaining an accurate determination of a platelet count in a patient with an underlying thrombocytopenic disorder.

More generally, platelet clumping in collected blood samples can cause inaccurate results on automated hematology instruments. As many as ten percent (10%) of clinical blood specimens collected into tubes containing EDTA alone have some degree of clumping (Savage et al., Am. J. Clin. Pathol. 81:317-322 (1984)). Although contemporary hematology analyzers are programmed to alert the operator to clumped samples, these algorithms do not always function perfectly. In this case, a blood smear is microscopically inspected for presence of clumps. However, as the EDTA blood stands in the test tube, changes in cellular morphology begin to take place as early as one hour post-collection, which makes the interpretation difficult (Narasimha A et al., Indian J. Hematol. Blood Transfus. 24:43-8 (2008)).

Further, EDTA causes platelets to become activated, which detracts from its anticoagulant properties. Platelet activation is characterized by mobilization of intracellular calcium, surface expression of α-granule membrane protein, P-selectin, and selective release of the contents of α-granules, many of which are involved in wound repair, coagulation and inflammation. Consequently, levels of certain cytokines, chemokines and growth factors are amplified, such that they may no longer reflect the actual amount present in the systemic circulation. This result presents a challenge for the use of EDTA in proteomic analyses, tests in the field of molecular biology, virology and infectious diseases, and in applications where sample stability needs to be ensured, such as blood banking or cell-based therapies.

As such, a need exists in the art for blood and plasma collection devices that allow anti-coagulants such as EDTA to function in preventing coagulation but without causing platelet activation.

### SUMMARY OF THE INVENTION

A first aspect of the present invention is directed to a device for collecting and stabilizing blood or plasma, comprising a first end and a second end and at least one interior wall defining a reservoir portion for receiving whole blood or plasma, and which comprises an anticoagulant, an antiplatelet agent comprising a prostaglandin, a prostacyclin, a phosphodiesterase inhibitor, a cyclooxygenase inhibitor, or a combination or two or more thereof, and a solubilization agent, wherein the anticoagulant and the antiplatelet agent are each present in an amount to stabilize the blood or plasma. In some embodiments, e.g., when the collected blood or plasma is subsequently analysed for the presence or amount of a biomarker (that is correlated with a disease condition), the device also contains, preferably in the reservoir thereof, at least one and preferably a cocktail of protease inhibitors and/or at least one esterase inhibitor.

Another aspect of the present invention is directed to a method of stabilizing blood or plasma during storage, comprising collecting whole blood or plasma into a device comprising a first end and a second end and at least one interior wall defining a reservoir portion for receiving whole blood or plasma, and which comprises an anticoagulant and an antiplatelet agent comprising a prostaglandin, a prostacyclin, a phosphodiesterase inhibitor, a cyclooxygenase inhibitor, or a combination of two or more thereof, and a solubilization agent, wherein the anticoagulant and the antiplatelet agent are each present in an amount to stabilize the blood or plasma.

A further aspect of the present invention is directed to a method of measuring a parameter of blood or plasma, comprising a) collecting whole blood or plasma into a device, comprising a first end and a second end and at least one interior wall defining a reservoir portion for receiving whole blood or plasma, and which comprises an anticoagulant and an antiplatelet agent comprising a prostaglandin, a prostacyclin, a phosphodiesterase inhibitor, a cyclooxygenase inhibitor, or a combination of two or more thereof, and a solubilization agent, wherein the anticoagulant and the antiplatelet agent are each present in an amount to stabilize the blood or plasma; and b) measuring the blood parameter at a predetermined time subsequent to the collecting, and comparing the measured blood parameter to a control.

In some embodiments, the device also contains a separator. In some embodiments, the device also contains (e.g., disposed in the reservoir and/or disposed on the interior wall, or both) an additional blood stabilization agent, that may include a protease inhibitor, an esterase inhibitor or both. In some other embodiments, the additional stabilization agent includes a plurality or cocktail of protease inhibitors (e.g., a serine protease inhibitor, a cysteine protease inhibitor, an exopeptidase inhibitor and a dipeptidyl peptidase inhibitor, and combinations of two or more thereof), with or without an esterase inhibitor.

### BRIEF DESCRIPTION OF THE DRAWINGS

FIG. 1 is a perspective view of a blood collection device of the present invention.

FIG. 2A is a bar graph showing that EDTA triggers platelet α-granule release but not dense granule/lysosomal release (comparing % CD62P expression with that of CD63). FIG. 2B is a bar graph that demonstrates that iloprost inhibits EDTA-mediated degranulation in terms of the mean percentage of CD62P⁺ platelets (bar graph ±SD) (as well as the median fluorescence intensity (MFI), and that the inhibition occurs across a wide concentration range of iloprost.

FIGS. 3A and B are bar graphs showing that iloprost inhibits agonist-induced platelet degranulation in EDTA for α-granules (3A) and for dense/lysosomal release (3B). The percentage of CD62P⁺ events for each condition is shown as the mean±SD for 3 subjects. The percentage of CD63⁺ events for each condition is shown as the mean±SD for 3 subjects.

FIG. 4A 1-2 is a histogram that demonstrates the ability of iloprost to inhibit EDTA-mediated platelet degranulation out to 24 hours of sample dwell, in terms of an example of a CD62P expression profile (1 subject) as compared to EDTA alone. FIG. 4B is a bar graph in the middle panel represents the percentage of CD62P⁺ events for EDTA and EDTA with iloprost at each timepoint shown as the mean±SD for 10 subjects.

FIG. 5 is a bar graph showing that increased levels of leukocyte-platelet aggregates in EDTA were inhibited by iloprost, (n=6).

FIG. 6 is a graph of a CBC analysis demonstrating that the combination of EDTA and iloprost reduces Mean Platelet Volume (MPV), compared to EDTA alone.

FIGS. 7A-E are dot plot graphs demonstrating the inhibition of EDTA-mediated spontaneous release of biomarkers (growth factors, cytokines and chemokines) as demonstrated by reduced levels of PDGF_{a/a} (A), TGFβ₁ (B), VEGF (C), IL-8 (CXCL8) (D), and RANTES (CCL5) (E) in the presence of iloprost as compared to EDTA alone.

FIGS. 8A-E are graphs demonstrating that iloprost reduces background level variability and improves consistency across all subjects when measuring platelet derived markers (CD62P(A), TGFβ₁(B), RANTES (CCL5)(C), PDGF_{a/a}(D) and VEGF(E)) in EDTA plasma within 24 hours.

FIGS. 9A-E are graphs that show that CD62P is a good proxy marker for measurement of platelet-derived biomarkers as demonstrated by strong correlation between surface expression of CD62P and select factors (PDGF_{a/a}(A) and TGFβ₁(C)). Weak correlation was determined for RANTES (CCL5)(B) and VEGF(D), and no correlation was determined for IL-8(E).

FIG. 10 is a bar graph showing that expression of CD62P is similar between EDTA and EDTA with a protease inhibitor cocktail, both in the presence and absence of iloprost, indicating that artificial release of biomarkers in the ETDA/protease inhibitor background is inhibited by iloprost.

FIG. 11 is a bar graph showing improved iloprost recovery in the presence of (2-hydroxypropyl)-β-cyclodextrin.

### DETAILED DESCRIPTION OF THE INVENTION

The collection devices of the present invention are used to collect and stabilize whole blood or plasma. Broadly, the blood sample collection devices of the present invention can encompass any collection device including tubes such as test tubes, capillary tubes, and centrifuge tubes; closed system blood collection devices, such as evacuated blood collection tubes, collection bags; syringes, especially pre-filled syringes; catheters; microtiter and other multi-well plates; arrays; laboratory vessels such as flasks, spinner flasks, roller bottles, vials, microscope slides, microscope slide assemblies, coverslips, films and porous substrates and assemblies; pipettes and pipette tips; tissue and other biological sample collection containers; and any other container suitable for holding a biological sample, as well as containers and elements involved in transferring samples and conducting apheresis (an illustration of the latter is described in U.S. Pat. No. 7,582,049). Examples and illustrations of several such devices are disclosed in commonly owned U.S. Pat. No. 7,309,468.

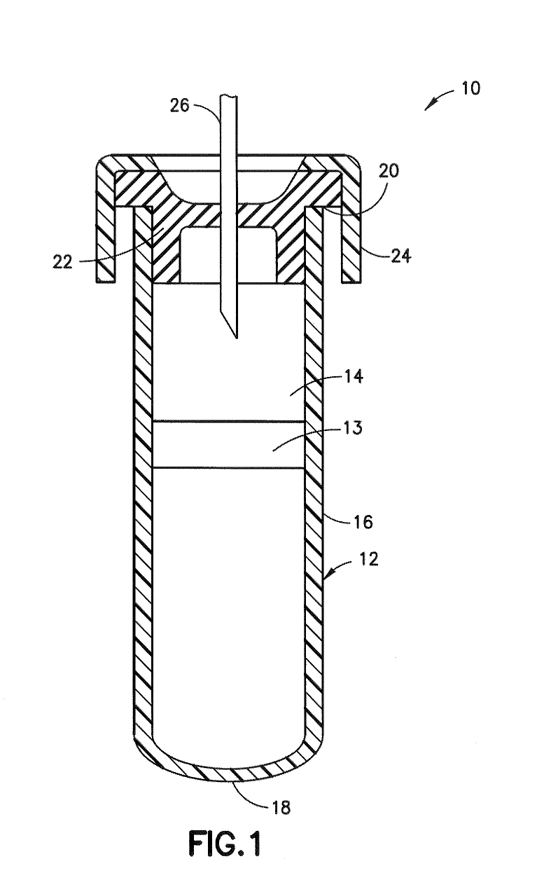

FIG. 1, which is also illustrated in U.S. Pat. No. 7,309,468, shows a typical blood collection device 10, useful in the present invention, which includes a container 12 defining an internal chamber or reservoir 14. In the embodiment illustrated, container 12 is a hollow tube having a side wall 16, a closed bottom end 18 and an open top end 20. Optionally, a separating member 13 is provided within the container chamber 14. Separating member 13 serves to assist in separating components of the blood sample, for example, by centrifugation. Container 12 is dimensioned for collecting a suitable volume of blood. A closure 22 for covering open end 20 to close container 12 is necessary where a sterile product is demanded. In some embodiments, the tube is configured for a screw cap. In embodiments wherein the tube is evacuated, however, a tight fitting, elastomeric plug is generally employed to contain the vacuum during the required storage periods. Preferably, closure 22 forms a seal capable of effectively closing container 12 and retaining a biological sample in chamber 14. Closure 22 may be one of a variety of forms including, but not limited to, rubber closures, HEMOGUARD™ closures, metallic seals, metal banded rubber seals and seals of different polymers and designs. A protective shield 24 may overlie closure 22.

Container 12 can be made of any material suitable for laboratory vessels, including, for example plastics (e.g., polyolefins, polyamides, polyesters, silicones, polyurethanes, epoxies, acrylics, polyacrylates, polyesters, polysulfones, polymethacrylates, PEEK, polyimide and fluoropolymers) and glass products including silica glass. Preferably, container 12 is transparent. Examples of suitable transparent thermoplastic materials for container 12 include polycarbonates, polyethylene, polypropylene and polyethyleneterephthalate. Plastic materials can be air impermeable materials or may contain an air impermeable or semi permeable layer. Alternatively, container 12 can be made of a water and air permeable plastic material.

The pressure in chamber 14 is selected to draw a predetermined volume of biological sample into chamber 14. Preferably, closure 22 is made of a resilient material that is capable of maintaining the internal pressure differential between atmospheric pressure and a pressure less than atmospheric. Closure 22 is such that it can be pierced by a needle 26 or other cannula to introduce a biological sample into container 12 as known in the art. Preferably, closure 22 is resealable. Suitable materials for closure 22 include, for example, silicone rubber, natural rubber, styrene butadiene rubber, ethylene propylene copolymers, and polychloroprene.

Suitable examples of container 12 include single wall and multi-layer tubes.

Container 12 may also contain a separator such as a gel, a mechanical separator or other type of separating member (e.g., filter paper or the like). Separators are useful for blood plasma preparation, specifically to separate plasma from human or animal whole blood. The gel is desirably a thixotropic polymeric gel formulation. The gel may be a homopolymer or a copolymer and may include silicone based gels such as, for example, polysiloxanes, or organic hydrocarbon based gels such as, for example, polyacrylics, polyesters, polyolefins, oxidized cis polybutadienes, polybutenes, blends of epoxidized soybean oil and chlorinated hydrocarbons, copolymers of diacids and propandiols, hydrogenated cyclopentadienes and copolymers of alpha olefins with dialkylmaleates. Examples of mechanical separators that may be useful in the present invention are described in U.S. Pat. Nos. 6,516,953; 6,406,671; 6,409,528; and 6,497,325.

Container 12 may also be adapted for centrifugally separating lymphocytes and monocytes from heavier phases of a sample of whole blood. In such embodiments, the devices may also contain a liquid density gradient medium and a means for preventing mixing of the liquid density gradient medium with a blood sample prior to centrifugation. An example of a suitable lymphocyte/monocyte collection tube is disclosed in U.S. Pat. No. 5,053,134.

Aside from the embodiment illustrated in FIG. 1, other commercially available blood collection tubes suitable for use in the present invention include the following, all of which are sold by Becton, Dickinson and Company, Franklin Lakes, N.J., with all registrations and trademarks belonging to Becton, Dickinson and Company: VACUTAINER® EDTA tubes (e.g., catalog nos. 367650, 367653, 366450, 367841, 367856, and 367861); VACUTAINER® PST tubes (e.g., catalog nos. 367960, 367964, 367962, and 367961); VACUTAINER® CPT tubes (e.g., catalog nos. 362753 and 362760); and VACUTAINER® Heparin tubes (e.g., catalog nos. 367884, 367671, and 367874) and VACUTAINER® citrate tubes (e.g., catalog nos. 363083, 366415, and 369714) VACUTAINER® ACD tubes (e.g., catalog nos. 364606, 364012, and 364816), and non-evacuated BD Microtainer® Tubes with BD Microgard™ Closure (e.g., catalog nos. 365987, 365965, and 365974), conventional BD Microtainer® Tubes (e.g., catalog nos. 365956, 365957, 365958, 365959, 365971, and 365973); and BD Microtainer® MAP tube (e.g., catalog no. 363706). Many commercial blood collection tubes have standard volumes typically ranging from 250 microliters through and including about 10.0 ml, and in some cases up to 16 ml. Typical volumes include 250, 400, and 500 microliters, as well as 2.0 ml, 3.5 ml, 4.0 ml, 5.0 ml, 8.0 ml, 8.5 ml, and 10.0 ml.

In other embodiments, the device may comprise a reservoir integrated within a testing cartridge, the reservoir capable of holding a volume of whole blood in the range of 2 through 200 microliters, more preferably 50-150 microliters. Such cartridges are sold for instance under the trade name i-STAT® Point of Care System by Abbott Laboratories (Abbott Park, Ill.), and are usable with a hand held analyzer capable of interfacing with the cartridge. Examples of such cartridges and handheld analyzers usable with the present invention include the i-STAT® CHEM8+ cartridge and i-STAT® 1 handheld analyzer respectively. Such devices are taught for examples in U.S. Pat. Nos. 5,096,669; 5,112,455; 5,821,399; 5,628,961; 7,419,821; 6,750,053; and U.S. D337,164.

### Anti-Coagulants

Representative examples of anticoagulants that may be suitable for use in the present invention include heparin, citrate, oxalates, ethylenediaminetetraacetic acid (EDTA) and salts thereof such as the dipotassium salt, a combination of citrate, theophylline, adenosine and dipyridamole (known as CTAD), sodium polyanethol sulfonate, and acid citrate dextrose. In some embodiments, the anticoagulant is EDTA, dipotassium salt. Broadly, the anticoagulant is present in the device in an amount effective to inhibit blood coagulation. This amount generally ranges from a concentration of about 1 mM to about 200 mM, and in some other embodiments, from about 10 mM to about 50 mM, relative to volume of the blood or plasma collected into the device.

### Anti-Platelet Agents

Anti-platelet agents suitable for use in the present invention include prostaglandins, prostacyclin, phosphodiesterase inhibitors, cyclooxygenase inhibitors, and combinations of two or more thereof. Prostaglandins are divided into different families depending on their structure, each designated by a letter (A, E, F, G, H, or I). In addition to this letter, each individual prostaglandin carries a digit that indicates the number of double bonds in its fatty acid side chain. For example, prostaglandin E1 (PGE1) belongs to the E family and has only one double bond in its side chain. In addition to PGE1, an example of another prostaglandin that may be useful in the practice of the present invention includes PGE2.

Various prostacyclin analogs, known as prostacyclins, may also be useful as anti-platelet agents in the practice of the present invention. Representative examples include PGI2 (also known as prostacyclin), carbaprostacyclin, beraprost, iloprost, 5,6-dihydroprostacyclin, ciprostene, limaprost, 13,14-dehydro-15-cyclohexyl carbaprostacyclin, taprostene, and treprostinil (and its salts, e.g., treprostinil diethanolamine, also known as UT-15C). In certain embodiments, the prostacyclin is iloprost. On the other hand, taprostene may not be suitable for use in the present invention.

Phosphodiesterase inhibitors may also be useful as anti-platelet agents in the practice of the present invention. Phosphodiesterase inhibitors block one or more of the subtypes of the phosphodiesterase enzyme (PDE) (PDE1, PDE2, PDE3, PDE4, PDE5, and PDE10) and inhibit inactivation of the intracellular cyclic adenosine monophosphate (cAMP) and cyclic guanosine monophosphate (cGMP) which are known as secondary messengers in cells. Non-selective and selective PDE inhibitors may be useful. Representative examples of PDE inhibitors include MEP-1, Milrinone, Cilostamine, Dipyridamole, Zaprinast and IBMX (3-isobutyl-1-methylxanthine caffeine, theophylline, theobromine, aminophylline, oxtriphylline, dyphylline (also known as Dilor), pentoxifylline, isobutylmethylxanthine, and papaverine.

Cyclooxygenase inhibitors may also be useful as anti-platelet agents in the practice of the present invention. Cyclooxygenase (COX), also known as prostaglandin-endoperoxide synthase (PTGS), catalyzes the synthesis of prostanoids including prostaglandins, prostacyclin and thromboxane. Representative examples of cyclooxygenase inhibitors include non-steroidal anti-inflammatory agents, e.g., aspirin, indomethacin, ibuprofen, naproxen, meloxicam, diclofenac, piroxicam, tenoxicam, tenidap, and combinations of two or more thereof.

Broadly, the anti-platelet agent is present in the device in an amount effective to inhibit platelet aggregation. This amount generally ranges from a concentration of about 1×10⁻¹⁰ to about 1×10⁻¹ M, and in some other embodiments, from about 10⁻⁸ to about 10⁻⁴ M, and in some other embodiments, from about 1×10⁻⁷ to about 1×10⁻⁵ M, relative to volume of the blood or plasma collected into the device.

### Solubilization Agent

Solubilization agents may be present in the devices of the present invention. Among other advantages, they promote and enhance stability of the anti-platelet agent (and any other blood stabilization agents that may be present) during the manufacturing process. Representative examples of stabilization agents that may be useful in the practice of the present invention include polyethylene glycol (PEG), monomethoxypolyethyleneglycol (MPEG), PEG lipids, albumin, bovine serum albumin (BSA), and cyclodextrins. Examples of cyclodextrins are described in Loftsson, J. Pharm. Sci. 93(5):1091-1099 (2004); Loftsson et al., Expert Opin. Drug Del. 2:335-51 (2005); and Jansook et al., J. Pharm. Sci. 99(2):719-29 (2010). A preferred cyclodextrin is 2-hydroxypropyl-β-cyclodextrin. Broadly, the solubilization agent is present in the device in a concentration of about 1×10⁻⁶ to about 1×10² mg/ml, and in some embodiments, about 1×10⁻³ to about 1×10⁻¹ mg/ml, relative to volume of the blood or plasma collected into the device.

### Additional Blood Stabilization Agents

In some embodiments, the inventive blood collection container may include at least one additional stabilization agent, the type and number of which may be selected based on factors such as the type of clinical test to which the blood or plasma is put. The stabilization agent may include a protease inhibitor (other than EDTA). Protease inhibitors useful in the present invention exhibit inhibitory activity against one or more classes of proteases including, for example, serine proteases, cysteine proteases, sereine/cysteine proteases, metalloproteases, aspartic/calpain proteases, exopeptidases and dipeptidyl peptidases. Any and all combinations of two or more of these proteases are contemplated by the present invention. Thus, the device may contain a cocktail of two or more of such inhibitors, including for example, an inhibitor of a serine protease and an inhibitor of an exopeptidase, an inhibitor of a serine protease and an inhibitor of a cysteine protease, an inhibitor of a serine protease and an inhibitor of a dipeptidyl peptidase, an inhibitor of an exopeptidase and an inhibitor of a dipeptidyl peptidase, an inhibitor of a serine protease, an inhibitor of an exopeptidase, an inhibitor of a dipeptidyl peptidase and an inhibitor of a cysteine peptidase, and an inhibitor of a serine protease, an inhibitor of an exopeptidase and an inhibitor of a dipeptidyl peptidase. See, e.g., U.S. Pat. No. 7,309,468. The presence of at least one protease inhibitor, e.g., an inhibitor of serine proteases, is desirable in connection with proteomics, which as described herein, entails measuring presence or amount of a proteinaceous or peptide biomarker that is known or suspected to be correlated with a disease condition.

Representative examples of serine protease inhibitors include antipain, aprotinin, antithrombin, chymostatin, DFP, elastatinal, APMSF, phenylmethylsulfonyl fluoride (PMSF), AEBSF, TLCK, TPCK, leupeptin, trypsin, and soybean trypsin inhibitor. Concentrations of serine protease inhibitors generally range from about 0.1 μM to about 100 μM.

Representative examples of exopeptidase inhibitors that may be useful in the present invention include amastatin, bestatin, diprotin A, and diprotin B. Concentrations of exopeptidase inhibitors generally range from about 0.01 mM to about 1 mM.

Dipeptidyl peptidase activity (which includes DPP IV and DPP IV like activities) present in the circulation is highly specific in releasing dipeptides from the N-terminal end of biologically active peptides with proline or alanine in the penultimate position of the N-terminal sequence of the peptide substrate. The glucose-dependent insulinotropic polypeptides GIP1 42 and GLP 17 36, potentiate glucose induced insulin secretion from the pancreas (incretins), are substrates of DPP IV. The DPP IV enzyme releases the dipeptides tyrosinyl alanine and histidyl alanine, respectively, from the N-termini of these peptides both in vitro and in vivo. Mentlein, et al., Eur. J. Biochem. 214, 829 (1993). Representative examples of inhibitors of dipeptidyl peptidase IV (DPP IV) that may be useful in the present invention include vildagliptin, sitagliptin, saxagliptin, linagliptin, and alogliptin. Other DPP IV inhibitors include dipeptide compounds formed from an amino acid such as isoleucine, Asn, Asp, Glu, His, Pro, and Val, and a thiazolidine or pyrrolidine group, and sterioisomers e.g., L-threo and L-allo forms thereof, and inorganic and organic salts thereof (e.g., phosphate, sulfate, acetate, tartarate, succinate, and fumarate). Specific examples of the dipeptide compounds include L-threo-isoleucyl-thiazolidide, L-allo-isoleucyl-thiazolidide, L-threo-isoleucyl-pyrrolidide, and L-allo-isoleucyl-pyrrolidide. Concentrations of dipeptidyl peptidase inhibitor generally range from about 0.01 mM to about 1 mM.

Other stabilization agents include inhibitors of other classes of proteases. Thus, in further embodiments, the blood collection devices may also contain an inhibitor of a cysteine protease (e.g., IAA (indoleacetic acid) and E 64), a serine/cysteine protease (e.g., leupeptin, TPCK, PLCK HCL, 2 heptanone HCL, and antipain HCl), an aspartic protease (e.g., pepstatin, and VdLPFFVdL), a metalloprotease (e.g., EDTA, bestatin, 1,10 phenanthroline and phosphoramodon), a thiol protease, an aspartic/calpain protease (e.g., pepstatin, N-acetyl leu leu norleucinal and N-acetyl leu leu methioninal), a caspase, an endopeptidase (e.g., α2 macroglobulin (referred to as an universal endopeptidase inhibitor), α1 anti trypsin and thiorphan), and combinations of two or more thereof. Additional examples of protease inhibitors include soybean or lima bean trypsin inhibitor, pancreatic protease inhibitor, egg white ovostatin, and egg white cystatin. Persons skilled in the field of proteomics appreciate that a given inhibitor may exhibit inhibitory activity against one or more proteases in the same class of proteases, as well as inhibitory activity against one or more proteases in different classes of proteases. Bestatin and amastatin, for example, exhibit inhibitory activity against metalloproteases as well as exopeptidases.

In some embodiments, the additional stabilization agent may include an inhibitor of an esterase, e.g., carboxyesterases such as butylcholinesterase and acetylcholinesterase. These stabilization agents may provide additional protection against ex vivo degradation of proteins and peptides that require an aliphatic ester group for biological activity. An example is ghrelin, which is a marker of metabolic diseases such as diabetes. Esterase inhibitors may provide enhanced stabilization of other neuropeptides.

Butylcholinesterase (BChE) (E.C. 3.1.1.8), also known as serum or plasma cholinesterase, is believed to play a role in the body's ability to metabolize cocaine and other drugs such as succinylcholine and aspirin. See, Lockridge, “Genetic Variants of Human Serum Butyrylcholinesterase influence the metabolism of the muscle relaxant succinylcholine.” In, Kalow (ed.) Pharmacogenetics of Drug Metabolism New York: Pergamon Press, Inc, at pp. 15-50. BChE is normally present in human plasma in an amount of about 5 mg/l (or about 5 U/ml). BChE inhibitors useful in the present invention have a Ki value of no greater than about 0.5 μM (500 nM), or in some embodiments a Ki of not greater than about 0.05 μM (50 nM), or in yet other embodiments, a Ki of not greater than about 0.010 μM (10 nM) (and including all subranges therein). Ki's are kinetic variables (as opposed to physical properties such as molecular weight, melting and boiling points, etc.) and as such, may be subject to relatively wide variation, especially depending upon the methodology used to determine this value. Thus, the term “about” as used herein in connection with Ki values refers to a variability (i.e., a plus/minus value) of 50%.

A BChE inhibitor useful in the present invention is the compound 9-amino-1,2,3,4 tetrahydroacridine, also known as tacrine (and derivatives thereof). See, U.S. Pat. No. 4,816,456. Tacrine is a centrally acting cholinesterase inhibitor approved by the FDA for the treatment of Alzheimer's disease. It is marketed by Sciele Pharma under the tradename COGNEX. Representative examples of tacrine derivatives that may be suitable for use in the present invention are taught in U.S. Pat. No. 4,754,050 (formula (I) therein).

Specific tacrine derivatives embraced by formula (I) in the '050 patent include the following: 9-Amino-3,4-dihydroacridin-1(2H)-one; 9-Amino-3,4-dihydro-6-methylacridin-1(2H)-one; 9-Amino-3,4-dihydro-6-methoxyacridin-1(2H)-one; 9-Amino-3,4-dihydro-6-fluoroacridin-1(2H)-one; 9-Amino-6-chloro-3,4-dihydroacridin-1(2H)-one; 9-Amino-7-chloro-3,4-dihydroacridin-1(2H)-one; 9-Amino-3,4-dihydro-6-trifluoromethylacridin-1(2H)-one; 9-Amino-3,4-dihydro-7-nitroacridin-1(2H)-one; 7,9-Diamino-3,4-dihydroacridin-1(2H)-one; N-[9-Amino-3,4-dihydro-1(2H)-oxoacridin-7-yl]acetamide; 3,4-Dihydro-9-methylaminoacridin-1(2H)-one; 3,4-Dihydro-9-methylamino-7-nitroacridin-1(2H)-one; 3,4-Dihydro-9-propylaminoacridin-1(2H)-one; 3,4-Dihydro-9-[2-(dimethylamino)ethyl]aminoacridin-1(2H)-one; 9-Benzylamino-3,4-dihydroacridin-1(2H)-one; 9-Benzylamino-3,4-dihydro-6-methylacridin-1(2H)-one; 9-Benzylamino-3,4-dihydro-6-fluoroacridin-1(2H)-one; 9-Benzylamino-6-chloro-3,4-dihydroacridin-1(2H)-one; 9-Benzylamino-3,4-dihydro-6-trifluoromethylacridin-1(2H)-one; 3,4-Dihydro-9-(2-methylbenzylamino)acridin-1(2H)-one; 3,4-Dihydro-9-(3-methylbenzylamino)acridin-1(2H)-one; 3,4-Dihydro-9-(4-methylbenzylamino)acridin-1(2H)-one; 3,4-Dihydro-9-(2-methoxybenzylamino)acridin-1(2H)-one; 3,4-Dihydro-9-(3-methoxybenzylamino)acridin-1(2H)-one; 3,4-Dihydro-9-(4-methoxybenzylamino)acridin-1(2H)-one; 3,4-Dihydro-9-(2-fluorobenzylamino)acridin-1(2H)-one; 3,4-Dihydro-9-(3-fluorobenzylamino)acridin-1(2H)-one; 3,4-Dihydro-9-(4-fluorobenzylamino)acridin-1(2H)-one; 6-Chloro-3,4-dihydro-9-(4-fluorobenzylamino)acridin-1(2H)-one; 9-(2-Chlorobenzylamino)-3,4-dihydroacridin-1(2H)-one; 9-(3-Chlorobenzylamino)-3,4-dihydroacridin-1(2H)-one; 9-(4-Chlorobenzylamino)-3,4-dihydroacridin-1(2H)-one; 3,4-Dihydro-9-[(2,3,4,5,6-pentafluorobenzyl)amino]acridin-1(2H)-one; 3,4-Dihydro-9-(2-trifluoromethylbenzylamino)acridin-1(2H)-one; 3,4-Dihydro-6-fluoro-9-(2-trifluoromethylbenzylamino)acridin-1(2H)-one; 3,4-Dihydro-9-(3-trifluoromethylbenzylamino)acridin-1(2H)-one; 3,4-Dihydro-9-(4-trifluoromethylbenzylamino)acridin-1(2H)-one; 3,4-Dihydro-9-phenethylaminoacridin-1(2H)-one; 3,4-Dihydro-9-(4,4-diphenylbutyl)aminoacridin-1(2H)-one; 3,4-Dihydro-9-(4,4-diphenylbutylamino)-6-trifluoromethylacridin-1(2H)-one; 9-[4,4-Bis(3-fluorophenyl)butylamino]-3,4-dihydroacridin-1(2H)-one; 9-[4,4-bis(4-fluorophenyl)butylamino]-3,4-Dihydroacridin-1(2H)-one; 3,4-Dihydro-9-(3-phenoxypropylamino)acridin-1(2H)-one; 9-[2-[Bis(4-fluorophenyl)methoxy]ethylamino-3,4-dihydroacridin-1(2H)-one; 9-[4-(Benzyloxy)benzylamino]-3,4-dihydroacridin-1(2H)-one; 3,4-Dihydro-9-[(2-thienyl)methylamino]acridin-1(2H)-one; 9-Amino-2,3-dihydro-cyclopenta[b]quinolin-1-one; 9-Amino-1,2,3,4-tetrahydroacridin-1-ol; 9-Amino-6-chloro-1,2,3,4-tetrahydroacridin-1-ol; 9-Amino-7-chloro-1,2,3,4-tetrahydroacridin-1-ol; 9-Amino-6-methoxy-1,2,3,4-tetrahydroacridin-1-ol; 9-Amino-6-fluoro-1,2,3,4-tetrahydroacridin-1-ol; 9-Amino-1,2,3,4-tetrahydro-6-trifluoromethylacridin-1-ol; 9-Methylamino-1,2,3,4-tetrahydroacridin-1-ol; 9-Propylamino-1,2,3,4-tetrahydroacridin-1-ol; 9-[2-(Dimethylamino)ethyl]amino-1,2,3,4-tetrahydroacridin-1-o; 9-Benzylamino-1,2,3,4-tetrahydroacridin-1-ol; 9-Benzylamino-6-methyl-1,2,3,4-tetrahydroacridin-1-ol; 9-Benzylamino-6-fluoro-1,2,3,4-tetrahydroacridin-1-ol; 9-Benzylamino-6-chloro-1,2,3,4-tetrahydroacridin-1-ol; 9-Benzylamino-1,2,3,4-tetrahydro-6-trifluoromethylacridin-1-o; 9-(2-Methylbenzylamino)-1,2,3,4-tetrahydroacridin-1-ol; 9-(3-Methylbenzylamino)-1,2,3,4-tetrahydroacridin-1-ol; 9-(4-Methylbenzylamino)-1,2,3,4-tetrahydroacridin-1-ol; 9-(2-Methoxybenzylamino)-1,2,3,4-tetrahydroacridin-1-ol; 9-(3-Methoxybenzylamino)-1,2,3,4-tetrahydroacridin-1-ol; 9-(4-Methoxybenzylamino)-1,2,3,4-tetrahydroacridin-1-ol; 9-(2-Fluorobenzylamino)-1,2,3,4-tetrahydroacridin-1-ol; 9-(3-Fluorobenzylamino)-1,2,3,4-tetrahydroacridin-1-ol; 9-(4-Fluorobenzylamino)-1,2,3,4-tetrahydroacridin-1-ol; 6-Chloro-9-(4-fluorobenzylamino)-1,2,3,4-tetrahydroacridin-1-ol; 9-(2-Chlorobenzylamino)-1,2,3,4-tetrahydroacridin-1-ol; 9-(3-Chlorobenzylamino)-1,2,3,4-tetrahydroacridin-1-ol; 9-(4-Chlorobenzylamino)-1,2,3,4-tetrahydroacridin-1-ol; 1,2,3,4-Tetrahydro-9-(2-trifluoromethylbenzyl)aminoacridin-1-ol; 6-Fluoro-1,2,3,4-tetrahydro-9-(2-trifluoromethylbenzylamino)acridin-1-ol; 1,2,3,4-Tetrahydro-9-(3-trifluoromethylbenzylamino)acridin-1-ol; 1,2,3,4-Tetrahydro-9-(4-trifluoromethylbenzylamino)acridin-1-ol; 9-[(2,3,4,5,6-Pentafluorobenzyl)amino]-1,2,3,4-tetrahydroacridin-1-ol; 9-Phenethylamino-1,2,3,4-tetrahydroacridin-1-ol; 9-(4,4-Diphenylbutyl)amino-1,2,3,4-tetrahydroacridin-1-ol; 9-[4,4-Bis(3-fluorophenyl)butylamino]-1,2,3,4-tetrahydroacridin-1-ol; 9-[4,4-Bis(4-fluorophenyl)butylamino]-1,2,3,4-tetrahydroacridin-1-ol; 9-(3-Phenoxypropylamino)-1,2,3,4-tetrahydroacridin-1-ol; 9-[[2-[Bis(4-fluorophenyl)methoxy]ethyl]amino]-1,2,3,4-tetrahydroacridin-1-ol; 9-[4-(Benzyloxy)benzylamino]-1,2,3,4-tetrahydroacridin-1-ol; 9-[(2-Thienyl)methylamino]-1,2,3,4-tetrahydroacridin-1-ol; 9-Amino-3,4-dihydroacridine; 9-Amino-1-methyl-1,2,3,4-tetrahydroacridin-1-ol; 9-Amino-3,4-dihydro-2-methyleneacridin-1(2H)-one; 9-Amino-1,2,3,4-tetrahydro-cyclopenta[b]quinolin-1-ol; 2-(3-Oxoclohexen-1-yl)aminobenzonitrile; and 4-Chloro-2-(3-oxocyclohexen-1-yl)aminobenzonitrile.

Other butyrylcholinesterase inhibitors that may be suitable for use in the present invention include tacrine dimmers such as ethopropazine, phenopropazine, and derivatives thereof. See, e.g., U.S. Pat. Nos. 2,607,773 and 4,833,138. Ethopropazine, hydrochloride salt, has been approved by the FDA for use in treatment of Parkinson's disease.

Yet other butyrylcholinesterase inhibitors include hybrids of tacrine and (−)-huperzine A (which is an enantiomeric lycodine alkaloid isolated from the club moss Huperzia serrata of the Lycopodium species, Huperziaceae). Examples of Huperzine A tacrine hybrids are known in the art as Compounds 5a, 5b and 5c, and Huprine X. Their corresponding chemical names are as follows: ((9E)-N1-(7-(1,2,3,4-tetrahydroacridin-9-ylamino)heptyl)-9-ethylidene-4,4,7-trimethylbicyclo[3.3.1]non-6-ene-1,3-diamine)(5a); ((9E)-N1-(7-(1,2,3,4-tetrahydroacridin-9-ylamino)heptyl)-9-ethylidene-47-methylbicyclo[3.3.1]non-6-ene-1,3-diamine)(5b); ((9E)-N1-(7-(1,2,3,4-tetrahydroacridin-9-ylamino)heptylamino)-9-ethylidene-3-methylbicyclo[3.3.1]non-3-ene-1-carboxylic Acid Methyl Ester)(5c); and (1S)-7-chloro-15-ethyl-10-azatetracyclo[11.3.1.0̂{2,11}.0̂{4,9}]heptadeca-2(11),3,5,7,9,14-hexaen-3-amine) (Huprine X). Methods of synthesizing these compounds are disclosed in Gemma, et al., J. Med. Chem. 49(11):3421-25 (2006) (5a, 5b and 5c), and Camps, et al., Mol. Pharmacol. 57:409-17 (2000) (Huprine X).

The concentration of BChE generally ranges from about 5 μM to about 500 mM (i.e., 5×10⁸ nM), and in some embodiments ranges from about 0.5 μM to about 50 mM, and in yet other embodiments, from about 0.1 μM to about 10 mM. All subranges within these ranges are also contemplated. As in the case of the Ki values, the term “about” as used in connection with all concentration values disclosed herein refers to variability (plus/minus value) of 50%.

The additional stabilization agent may also include an inhibitor of another type of serum esterase, and specifically an inhibitor of another B esterase (of which BChE is a member). These esterases include acetylcholinesterase (AChE) (EC 3.1.1.7) and nonspecific carboxylesterase (EC 3.1.1.1). Inhibitors of AChE act upon cholinesterase and inhibit it from breaking down the acetylcholine which functions in the body as a neurotransmitter. Some BChE inhibitors such as tacrine and huperazine A are known to inhibit acetylcholinesterase as well. Tacrine has a reported Ki for AChE of 6.9 nm (Bencharit, et al., Chem. Biol. 10:341-9 (2003)). Huperzine A has a reported Ki for AChE of 47 nm (Gemma, et al., J. Med. Chem. 49:3421-5 (2006)). Given that BChE constitutes a significant portion of total esterase activity in human serum (i.e., about 5 mg/L of BChE compared to 0.008 mg/L for AChE), the inclusion of inhibitors in the blood collection tube is optional.

The Ki's of the AChE inhibitors suitable for use in the present invention are typically about 500 nm or less, and in other embodiments, less than about 400 nm, 300 nm, 200 nm, 100 nm, 50 nm or 10 nm. As disclosed herein, Ki values for a given AChE inhibitor can be determined in accordance with standard assay techniques.

Thus, other AChE inhibitors that may be useful in the present invention include the following: Huprine X ((1S)-7-chloro-15-ethyl-10-azatetracyclo[11.3.1.0̂{2,11}.0̂{4,9}]heptadeca-2(11),3,5,7,9,14-hexane-3-amine) (Ki of 0.026 nm); Tacrine Dimer 4a (methylbis[3-(1,2,3,4-tetrahydroacridin-9-ylamino)propyl]amine) (Ki of 0.06 nm); Tacrine Dimer 4d (2-{bis[3-(1,2,3,4-tetrahydroacridin-9-ylamino)propyl]amino}ethan-1-ol|N,N-Bis[3-[(1,2,3,4-tetrahydroacridin-9-yl)amino]propyl]-N-hydroxyethylamine) (Ki of 0.65 nm); Tacrine derivative 2 (6,8-dichloro-1,2,3,4-tetrahydroacridin-9-amine) (Ki of 1.0 nm); Tacrine Dimer 3b (Homodimeric Tacrine Analog 3b|N-[7-(1,2,3,4-tetrahydroacridin-9-ylamino)heptyl]-1,2,3,4-tetrahydroacridin-9-amine|tacrine homobivalent compound 3a) (Ki of 1.3 nm); Tacrine Dimer 4c (N,N-Bis[3-[(1,2,3,4-tetrahydroacridin-9-yl)amino]propyl]-N-allylamine|prop-2-en-1-ylbis[3-(1,2,3,4-tetrahydroacridin-9-ylamino)propyl]amine) (Ki of 1.6 nm); Tacrine Dimer 3c (Homodimeric Tacrine Analog 3c|N-[8-(1,2,3,4-tetrahydroacridin-9-ylamino)octyl]-1,2,3,4-tetrahydroacridin-9-amine) (Ki of 1.9 nm); Tacrine Dimer 4b (N,N-Bis[3-[(1,2,3,4-tetrahydroacridin-9-yl)amino]propyl]-N-ethylamine|ethylbis[3-(1,2,3,4-tetrahydroacridin-9-ylamino)propyl]amine) (Ki of 2.8 nm); tacrine heterobivalent compound 3c (N-{7-[(6,8-dichloro-1,2,3,4-tetrahydroacridin-9-yl)amino]heptyl}-1,2,3,4-tetrahydroacridin-9-amine) (Ki of 6.0 nm); Huperzine A-Tacrine Hybrid 5c ((9E)-7-(7-(1,2,3,4-Tetrahydroacridin-9-ylamino)heptylamino)-9-ethylidene-3-methylbicyclo[3.3.1]non-3-ene-1-carboxylic Acid Methyl Ester|methyl (1S)-9-ethylidene-3-methyl-7-{[7-(1,2,3,4-tetrahydroacridin-9-ylamino)heptyl]amino}bicyclo[3.3.1]non-3-ene-1-carboxylate) (Ki of 6.4 nm); Tacrine Dimer 4j (N-Methyl-N-(1,2,3,4-tetrahydroacridin-9-yl)-N-[3-(1,2,3,4-tetrahydroacridin-9-ylsulfanyl)propyl]-1,3-propanediamine methyl[3-(1,2,3,4-tetrahydroacridin-9-ylamino)propyl][3-(1,2,3,4-tetrahydroacridin-9-ylsulfanyl)propyl]amine) (Ki of 9.1 nm); Huperzine A-Tacrine Hybrid 5b ((9E)-N1-(7-(1,2,3,4-Tetrahydroacridin-9-ylamino)heptyl)-9-ethylidene-7-methylbicyclo[3.3.1]non-6-ene-1,3-diamine|N-(7-{[(1S)-1-amino-9-ethylidene-7-methylbicyclo[3.3.1]non-6-en-3-yl]amino}heptyl)-1,2,3,4-tetrahydroacridin-9-amine) (Ki of 15.70 nm); Huperzine A-Tacrine Hybrid 5a (9E)-N1-(7-(1,2,3,4-Tetrahydroacridin-9-ylamino)heptyl)-9-ethylidene-4,4,7-trimethylbicyclo[3.3.1]non-6-ene-1,3-diamine|N-(7-{[(1S)-1-amino-9-ethylidene-4,4,7-trimethylbicyclo[3.3.1]non-6-en-3-yl]amino}heptyl)-1,2,3,4-tetrahydroacridin-9-amine) (Ki of 16.50 nm); AP2238 3-(4-{[Benzyl(methyl)amino]methyl}-phenyl)-6,7-dimethoxy-2H-2-chromenone|3-(4-{[benzyl(methyl)amino]methyl}phenyl)-6,7-dimethoxy-2H-chromen-2-one) (Ki of 21.70 nm); Tacrine Dimer 4i (N-(1,2,3,4-Tetrahydroacridin-9-yl)-N-[8-(1,2,3,4-tetrahydroacridin-9-yl)oct-1-yl]amine|N-[8-(1,2,3,4-tetrahydroacridin-9-yl)octyl]-1,2,3,4-tetrahydroacridin-9-amine) (Ki of 30 nm); tacrine heterobivalent compound 3g (6,8-dichloro-N-[7-(1,2,3,4-tetrahydroacridin-9-ylsulfanyl)heptyl]-1,2,3,4-tetrahydroacridin-9-amine) (Ki of 41 nm); Tacrine Dimer 4m (N-[3-(1,2,3,4-Tetrahydroacridin-9-ylamino)propyl]-N-[4-(1,2,3,4-tetrahydroacridin-9-ylsulfanyl)butyl]acetamide) (Ki of 47 nm); 9-Amino-6-Chloro-2-Methoxyacridine (6-chloro-2-methoxyacridin-9-amine) (Ki of 49 nm); Tacrine Dimer 4k (N-[3-(1,2,3,4-Tetrahydroacridin-9-ylamino)propyl]-N-[3-(1,2,3,4-tetrahydroacridin-9-ylsulfanyl)propyl]acetamide) (Ki of 50 nm); tacrine heterobivalent compound 3i (N-[6-(1,2,3,4-tetrahydroacridin-9-ylsulfanyl)hexyl]-1,2,3,4-tetrahydroacridin-9-amine) (Ki of 100 nm); tacrine homobivalent compound 3b (6,8-dichloro-N-{7-[(6,8-dichloro-1,2,3,4-tetrahydroacridin-9-yl)amino]heptyl}-1,2,3,4-tetrahydroacridin-9-amine) (Ki of 150 nm); Tacrine Dimer 3a (N-[5-(1,2,3,4-tetrahydroacridin-9-ylamino)pentyl]-1,2,3,4-tetrahydroacridin-9-amine) (Ki of 210 nm); Tacrine Dimer 4g (N-[8-(1,2,3,4-tetrahydroacridin-9-ylsulfanyl)octyl]-1,2,3,4-tetrahydroacridin-9-amine) (Ki of 250 nm); tacrine heterobivalent compound 3f (N-{7-[(6,8-dichloro-1,2,3,4-tetrahydroacridin-9-yl)sulfanyl]heptyl}-1,2,3,4-tetrahydroacridin-9-amine) (Ki of 290 nm); 1,2-Dione-Based Compound, 8 (1,2-dihydronaphthalene-1,2-dione|1,2-naphthoquinone) (Ki of 320 nM); Tacrine Dimer 4f (N-[7-(1,2,3,4-tetrahydroacridin-9-ylsulfanyl)heptyl]-1,2,3,4-tetrahydroacridin-9-amine|tacrine heterobivalent compound 3e) (Ki of 340 nm); and 6,9-Diamino-2-Ethoxyacridine (7-ethoxyacridine-3,9-diamine) (Ki of 490 nm). Ki values disclosed herein for the forementioned AchE inhibitors are reported in Gemma, et al., J. Med. Chem. 49:3421-5 (2006); Campiani, et al., J. Med. Chem. 48:1919-29 (2005); Wong, et al., J. Am. Chem. Soc. 125:363-73 (2003); Savini, et al., Bioorg. Med. Chem. Lett. 11:1779-82 (2001); Piazzi, et al., J. Med. Chem. 46:2279-82 (2003); Bencharit, Supra.; and Hyatt, et al., J. Med. Chem. 50:5727-34 (2007).

Even further examples of AChE inhibitors that may be useful in the present invention include the following: organophosphates (e.g., Metrifonate, Echothiophate, diisopropyl fluorophosphates, Cyclosarin, Dimethoate, Sarin, Soman, Tabun, VX, VE, VG, VM, Diazinon, Malathion, and Parathion); carbamates (e.g., Physostigmine, Neostigmine, Pyridostigmine, Ambenonium, Demarcarium, Rivastigmine, Aldicarb, Bendiocarb, Bufencarb, Carbaryl, Carbendazim, Carbetamide, Carbofuran, Chlorbufam, Chloropropham, Ethiofencarb, Formetanate, Methiocarb, Methomyl, Oxamyl, Phenmedipham, Pinmicarb, Pirimicarb, Propamocarb, Propham, and Propoxur); Penanthrene derivatives (e.g., galantamine); piperidines (e.g., Donepezil (E2020) (Ki of 2.9 nm)); Edrophonium; and natural compounds (e.g., galantamine and Onchidal).

Since some BChE inhibitors also exhibit potent AChE inhibitory activity, embodiments of the present invention may include a single esterase inhibitor that possesses both BChE and AChE inhibitory activities.

The concentration of the additional serum esterase inhibitor that may be present in the blood collection device generally ranges from about 0.1 μM to about 70 mM, and in some embodiments, from about 1 mM to about 7 mM.

In another embodiment, the cocktail includes a serine protease and at least one other class of protease inhibitor, e.g., a cysteine protease inhibitor, and/or at least one esterase inhibitor. The blood stabilization agents (e.g., the anticoagulant, the antiplatelet agent, and any additional blood stabilization agent) and the solubilization agent (collectively referred to as the “stabilization agent”) may be present in the device in any suitable form, including liquids (e.g., solutions and suspensions) and solids (e.g., pellet, tablet, capsule, spray dried material, freeze dried material, powder, particle, crystals, and lyophilized material) and semi solids (e.g., gel). Lyophilization may be particularly useful in that it provides good stability (e.g., in terms of maximizing shelf life of the stabilization agent) and also allows for subsequent sterilization. For example, the stabilizing agent may be introduced into the container of the device in the form of a liquid composition, and then lyophilized by standard techniques. Freeze drying, for example, entails freezing the liquid composition and then slowly warming after freezing, while simultaneously applying a vacuum, such that a freeze dried powder remains in the collection device. Various additives such as PVP or trehalose may be added to the liquid composition prior to freeze drying to facilitate pelletizing of the stabilization agent and reconstitution of the lyophilized agents upon contact with blood. Vacuum drying may also be used after adding the liquid composition. In other embodiments, the stabilizing agent is formed into a liquid or solid aerosol and sprayed onto one or more surfaces of the interior of the container. Encapsulating or formulating the stabilization agent in the form of a tablet protects it from light exposure and prevent other undesirable interactions between the inhibitors and other elements in the container. Encapsulation materials and excipients useful in making tablets and capsules that dissolve upon sample collection are well known in the art.

In addition to being disposed in the reservoir, the stabilization agent may be located on any surface of the collection device that comes into contact with the collected blood. For example, the stabilization agent may also be located on stoppers and seals for closing the device, or on mechanical, or other inserts placed within the device.

In addition to the stabilization agent, the device of the present invention may also contain carrier media (e.g., water or alcohol), stabilizing or reconstitution media (e.g., polyvinylpyrollidone, trehalose, mannitol, etc.) and/or one or more other additives useful in the art of blood and plasma collection, and which are substantially inert with respect to peptides and proteins. Typical additives include phenol, phenol/chloroform mixtures, alcohols, aldehydes, ketones, organic acids, salts of organic acids, alkali metal salts of halides, organic chelating agents, fluorescent dyes, antibodies, binding agents, antioxidants, reducing agents, and buffering agent. Where the inhibitors are in tablet form, pharmaceutical tablet disintegrating materials, which are known to those skilled in the art, may be included, if desired.

A useful manufacturing process for a device of the present invention involves obtaining a collection container, such as a tube; adding the anticoagulant, anti-platelet agent, solubilization agent, and any other stabilization agent(s) to the container by the process of spraying a solution or suspension of the additives into the container and then removing the solvent by forced air drying. The solution or suspension of the additives can be formulated in an organic solvent or, preferably, water. Alternatively, lyophilization can be used to remove the solvent. The container is then evacuated and sterilized. A separating member may be added to the container, if desired. An example of a suitable lyophilization/evacuation process is as follows: the container is frozen at a temperature of about 40° C. at a pressure of about 760 mm for about 6 to 8 hours; the container is dried as the temperature is increased from 40° C. to about 25° C., at a pressure of about 0.05 mm, for about 8 to 10 hours; and the container is then evacuated at a temperature of about 25° C. and a pressure of about 120 mm for about 0.1 hours. Preferably, the sterilization technique is with cobalt 60 radiation.

The whole blood or plasma-containing component(s) thereof may be withdrawn from the patient directly into the blood collection device without any intervening process steps. It has been found that collecting the whole blood directly from the patient, and introducing the sample directly into the device containing the stabilization agent substantially prevents the activation of proteins that otherwise occurs when the sample is stored before combining it with the stabilization agent. The method of the present invention is useful both with open collection devices and with closed collection devices wherein the opening is closed by a closure means.

In a preferred embodiment, the collection device is a tube which is used for drawing a whole blood sample directly from a patient for stabilizing the platelets immediately at the point of collection. The collection tube may be an evacuated system for collecting blood. Alternatively, the tube may be a partially evacuated or a non-evacuated system (e.g., a capillary collection tube) for collecting blood. A suitable example of an evacuated system is a closed tube. A manual syringe draw is a suitable example of both a partially evacuated and a non-evacuated system. Non-evacuated systems may also include automatic draw systems. Evacuated systems are particularly preferred.

The blood or a platelet-containing portion thereof collected using the present invention may then be subjected to any number of clinical analysis.

For example, hematology involves analysis of blood cells or their constituents, such as hemoglobin. The most commonly performed test is the complete blood count (CBC) also called full blood count (FBC). In practice, hematology analyzers (“blood cell counters”) of varying sophistication are used for cell counting in all but the smallest hematology laboratories. In addition to providing cell counts and graphical displays of the information recovered, these instruments also provide a warning (“flag”) that atypical cells were found and provide a presumptive identification of the abnormality. Platelet clumping can cause falsely depressed platelet results on automated hematology instruments, which are typically programmed to alert the operator to clumped samples (these algorithms may not always function properly). In this case, a blood smear is microscopically inspected for presence of clumps. If an accurate platelet count is needed, a fresh blood sample is obtained from the patient in either the same anticoagulant (EDTA) or citrate. Up to 10% of clinical blood specimens collected into EDTA alone have some degree of platelet clumping. Peripheral blood smear involves microscopic examination of the peripheral blood to supplement the information provided by automated hematology analyzers. Hematology is also routinely used in veterinary medicine to evaluate the health status of animals and poultry and EDTA is the anticoagulant of choice for hematology in mammals. However, determining an accurate platelet count is frequently adversely affected by prominent aggregation of platelets and by the presence of platelets too large to be counted, especially when using impedance-type hematology analyzers. The present invention may serve to reduce the incidence of platelet clumping. Thus, employment of the present invention in these contexts would be advantageous.

The field of plasma proteomics was developed through the identification of proteins or peptides in serum/plasma that correlate with or that are diagnostic of a disease condition. Measuring the presence or levels of these biomarkers may also be clinically advantageous from the standpoint of monitoring the response to treatment. These biomarkers are susceptible to systematic degradation by endogenous proteases, almost immediately upon removal from the circulatory system. Because of its chelating action, EDTA is the anticoagulant of choice for plasma proteomics. However, spontaneous activation of platelets mediated by EDTA can lead to ex vivo protein degradation and result in distinct and multiple peptide signals in plasma samples. Stabilization of blood using the present invention may reduce the amount of degradation of biomarkers that is catalyzed by protease enzymes.

Many of the factors contained in platelet α-granules are involved in wound repair, coagulation and inflammation such as TGFβ1, PDGF, fibronectin, β-thromboglobulin, vWF, fibrinogen, FV and FXIII. Accurate measurements of some of these factors have important clinical consequences. For example, measurements of TGFβ1, whose elevated levels have been reported in a number of human disorders, including coronary artery disease and malignancies, may be confounded by uncontrolled in vitro release of platelet TGFβ1 during blood collection and/or plasma preparation (Meyer et al., Blood 119:1064-74 (2012)).

Platelets, besides their hemostatic activity, also function as cells that promote immunity and inflammation (Semple et al., Nat. Rev. Immunol. 11:264-74 (2011)). The proinflammatory activity of platelets occurs through multiple mechanisms, including receptor-mediated cross talk with and activation of different cells, as well as release of potent biologically active mediators stored in their granules. This interaction is bidirectional as the activated cells in turn activate platelets. This amplifies levels of certain cytokines, chemokines and growth factors such that assays, such that they may no longer reflect the actual amount present in the systemic circulation. For example, interaction with T-cells (via CD40-CD40L) causes platelet activation and triggers release of granular RANTES, a mediator of acute and chronic inflammation (Danese et al., J. Immunol. 172:2011-5 (2004)). Therefore, when used for cytokine measurement, EDTA-anticoagulated blood should be processed as quickly as possible in order to avoid spurious releases resulting from platelet activation. The use of the devices of the present invention reduces the incidence of spurious release.

Blood Banking—

Millions of blood products are transfused every year; many lives are thus directly concerned by transfusion. The three main labile blood products used in transfusion are erythrocyte concentrates, platelet concentrates and fresh frozen plasma. The standard procedure of blood products preparation from whole blood donation is as follows: once collected in plastic bags containing citrate phosphate dextrose (CPD) anticoagulant, whole blood is centrifuged in order to separate blood cells according to their size and density. Red blood cells (RBCs) settle, while plasma remains on the top. White blood cells and platelets (PLTs) form a “buffy coat” layer at the interface. Finally, the three components are distributed among the sterile inter-connected blood bags by applying a semi-automated pressure to the centrifuged bag containing the original whole blood donation.

Indeed, as leukocytes could be pathogen-containing cells, blood products are systematically leukodepleted. However, during storage, modifications or degradation of those components may occur, and are known as storage lesions. For RBCs, storage induces biomechanical changes, affects rheological properties (shape change, deformability, aggregability, and intracellular viscosity) and affects oxidative state of proteins. Platelet Storage Lesions (PSL) involve morphological changes, platelet activation, platelet proteolysis and platelet surface receptor expression. Changes of platelet membrane glycoproteins have also been reported. Granule release and platelet activation occur during PLT storage, as indicated by the accumulation of β-thromboglobulin and platelet factor 4 in the storage medium, and the increase in surface levels of P-selectin (CD62P), respectively. Thus, biomarker discovery of in vivo blood aging as well as in vitro labile blood products storage lesions is of high interest for the transfusion medicine community. All these blood-related studies can be impacted by pre-analytics, such as choice of anticoagulant. By mitigating platelet activation in accordance with the present invention, blood storage lesions are reduced or even eliminated which preserves quality of labile biomarkers and ensures the efficiency of transfusion therapy.

Platelet-rich plasma (PRP) is a concentrated source of autologous platelets and contains several different growth factors and other cytokines that stimulate healing of bone and soft tissue. PRP has been used in several medical applications, including orthopedics and sports medicine, or cardiac, plastic and oral surgery. PRP preparation involves the collection of whole blood into citrate-based anticoagulant, separation of the PRP fraction and activation in order to release factors that stimulate healing process. Therapeutic PRP concentrates platelets by roughly five-fold over baseline (Arnoczky, Am. J. Sports Med. 39:NP8-9 (2011)). Operative techniques in sports medicine). However, the variability in platelet concentrating techniques may alter platelet degranulation characteristics and affect clinical outcomes. Role of anticoagulant is equally important, as it must support the metabolic needs of platelets and enable viable separation of platelets in an undamaged manner. Although to a lesser extent, citrate anticoagulant is also known to induce artificial platelet activation (Ahnadi et al., Thromb. Haemost. 90:940-8 (2003)), mitigation of which in accordance with the present invention preserves quality of the PRP sample and ensures the efficacy of therapy.

Cell based immunotherapies have been proven to be effective for some cancers and employ immune effector cells such as lymphocytes, macrophages, dendritic cells, etc. The active agents of immunotherapy are collectively called immunomodulators and represent a diverse array of recombinant, synthetic and natural preparations, often cytokines or chemokines, such as CCL3. Also known as macrophage inflammatory protein-1α (MIP-1α), CCL3 is involved in the acute inflammatory state in the recruitment and activation of polymorphonuclear leukocytes and can also be released from activated platelets. Mitigating artificial platelet activation by use of the present invention reduces or even eliminates release of these immunomodulatory regulators in cell preparations intended for therapies.

Microparticles (MPs) are small (˜0.1 μm) membrane vesicles released from a variety of cells upon activation. The large majority of MPs detected in blood originates from platelets, but other blood cells such as leucocytes, erythrocytes, endothelial cells and even malignant cells may also shed MPs (Yuana et al., Thromb. Haemost. 105:396-408 (2011)). Plasma levels of MPs are elevated in many pathological conditions, including vascular disorders, cancer and autoimmune disease (Garcia et al., J. Proteome Res. 4:1516-1521 (2005)). Therefore, there is a growing interest to study the role of MPs in physiology and pathology. However, individual studies use a wide variation of pre-analytical and analytical procedures, which all may affect the outcome of the MP measurement. During blood collection, it is necessary to prevent ex vivo platelet activation, because platelet activation will result in release of alpha and dense granules and platelet MPs. Thus, use of the present invention in this context will prove advantageous as well.

The present invention will now be described by way of the following non-limiting examples.

### Example 1

### Iloprost Inhibits EDTA-Mediated Spontaneous Platelet Degranulation

Platelet activation can result in a robust and rapid release of α-granules, dense granules, and lysosomes, the contents of which serve to promote a variety of autocrine and paracrine signal transduction events. CD62P (P-selectin) is an adhesion molecule that is transiently expressed on the platelet plasma membrane following α-granule release and can mediate platelet-leukocyte aggregates via ligation with leukocyte expressed P-selectin glycoprotein ligand 1 (PSGL-1/CD162). Dense granule and lysosome release can be measured, although not distinguished, with CD63 surface expression. Previous studies demonstrate that ETDA induces surface expression of CD62P and CD63.

The effect of EDTA on platelet activation, as judged by CD62P and CD63 surface expression, was evaluated in the presence or absence of the platelet stabilization agent (iloprost). Whole blood was collected into tubes containing EDTA or EDTA with iloprost at 0.5, 5 and 50 μM final concentration. Antibody cocktails containing previously determined amounts of αCD61 PerCP, αCD62P PE, αCD63 Alexa Fluor® 647, and/or appropriate isotype controls were added to a conical bottom micro titer plate. A modified HEPES-Tyrode's buffer was used to equilibrate the final volume to 100 μL for each staining reaction. Platelet surface staining was performed by adding 5 μL of whole blood to the appropriate staining mix and incubating at RT under dark conditions for 15 minutes. Afterwards, the entire reaction was transferred to 5 mL round bottom polystyrene snap cap tubes containing 1 mL of HEPES-Tyrode's buffer for a final dilution of each sample. Samples were briefly vortexed and data was acquired using a BD FACScalibur instrument. FSC and SSC settings were established on the log scale in order to discern platelet size and morphology from RBC and WBC populations. In order to further discriminate platelet-specific events, a PerCP alone control was used to establish a CD61⁺ gate. Since CD63 is not a platelet specific marker it was necessary to further gate on the single platelet morphology population to avoid a CD63 signature from the platelet-bound leukocytes. The PerCP alone control was also used to set fluorescence detector voltages for CD62P⁻/CD63⁻ populations. Once voltage and compensation settings were finalized, 10,000 CD61⁺/single platelet events were acquired for each test sample.

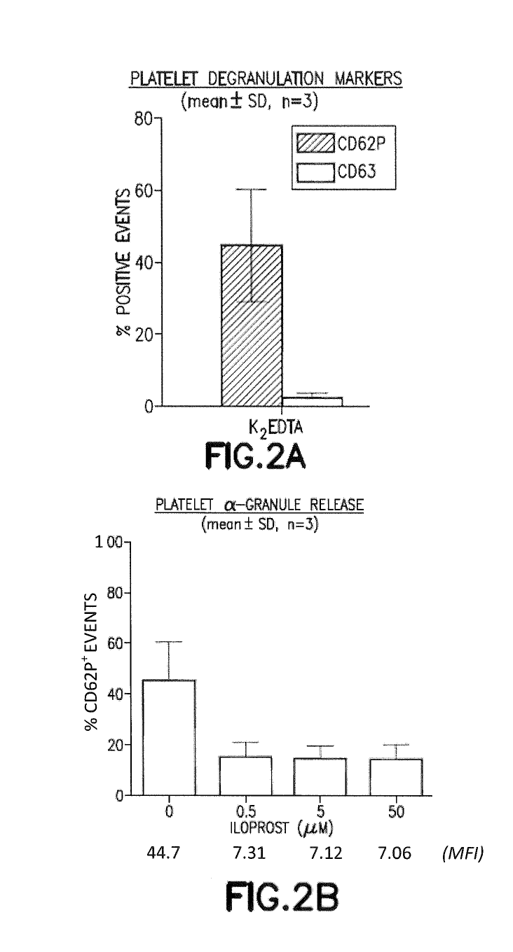

As illustrated in FIGS. 2A and B, adding iloprost in titrating amounts of 0.5, 5 and 50 μM decreased the frequency of CD62P expression from 44.7% to 15.0%, 14.1% and 13.9%, respectively. Although CD62P expression was not eliminated with any concentration of iloprost, the median PE fluorescence dropped from 44.7 in EDTA alone to 7.31, 7.12 and 7.06, along the titration curve, indicating that expression levels were lower in the remaining CD62P⁺ platelets in iloprost-treated samples.

### Example 2

### Iloprost Inhibits Agonist-Induced Platelet Degranulation in EDTA for α-Granules and for Dense/Lysosomal Release

The effect of iloprost on platelet activation was studied in the presence of strong platelet-activating agents, ADP and thrombin-receptor activating peptide (TRAP). Platelet stimulations were performed by adding 300 μL blood to micro-centrifuge tubes containing 10 μL of saline (0.85%), ADP, or TRAP-6 and incubating for approximately 2 min at RT. Final concentrations of ADP and TRAP-6 were 6.5 μM and 32 μM, respectively. Afterwards, whole blood flow cytometry was performed as described above. Blood collection and flow cytometry was performed as described in example 1.

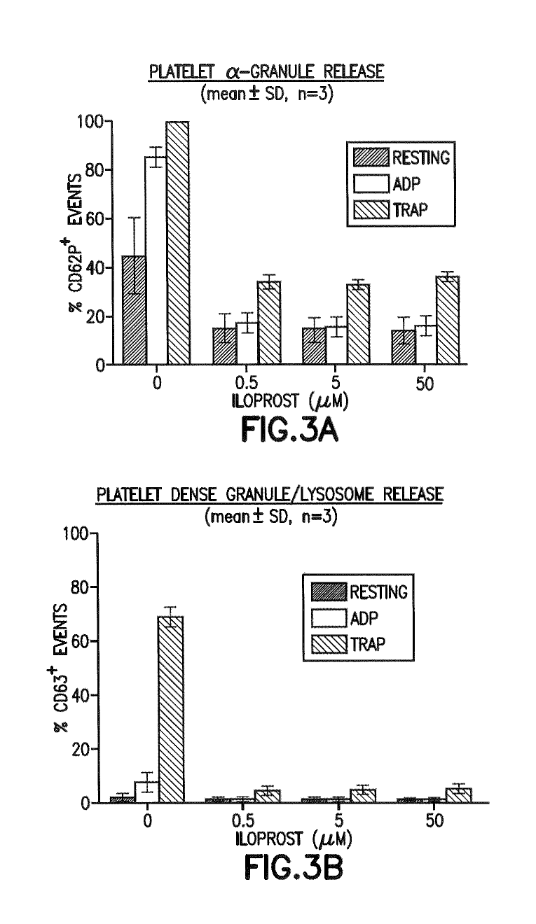

Addition of ADP increased the CD62P expression from 44.6% in EDTA alone (resting sample) to 85.1% while TRAP activation reached 99.4% (FIG. 3A). Addition of iloprost resulted in reduced expression of CD62P to 15.0% in resting samples and 17.3% or 33.4% in ADP or TRAP activated samples with the addition of 0.5 μM iloprost. Expression remained fairly consistent for different iloprost concentrations. For CD63 (FIG. 3B), addition of ADP resulted in a marginal increase (7.67%) in surface expression compared to unstimulated conditions (2.13%). The addition of iloprost reduced both unstimulated and ADP stimulated CD63 expression to a range of 1.17% to 1.30%, effectively blocking the ADP response. Stimulation with TRAP produced a robust upregulation of CD63 expression to 69.3%, which was reduced to a range of 4.3% to 5.2% with the addition of iloprost. Together, the combined upregulation of CD62P and CD63 in response to ADP or TRAP was markedly reduced by the addition of iloprost.

### Example 3

### Iloprost Inhibits EDTA-Mediated Degranulation Out to 24 Hr of Sample Dwell

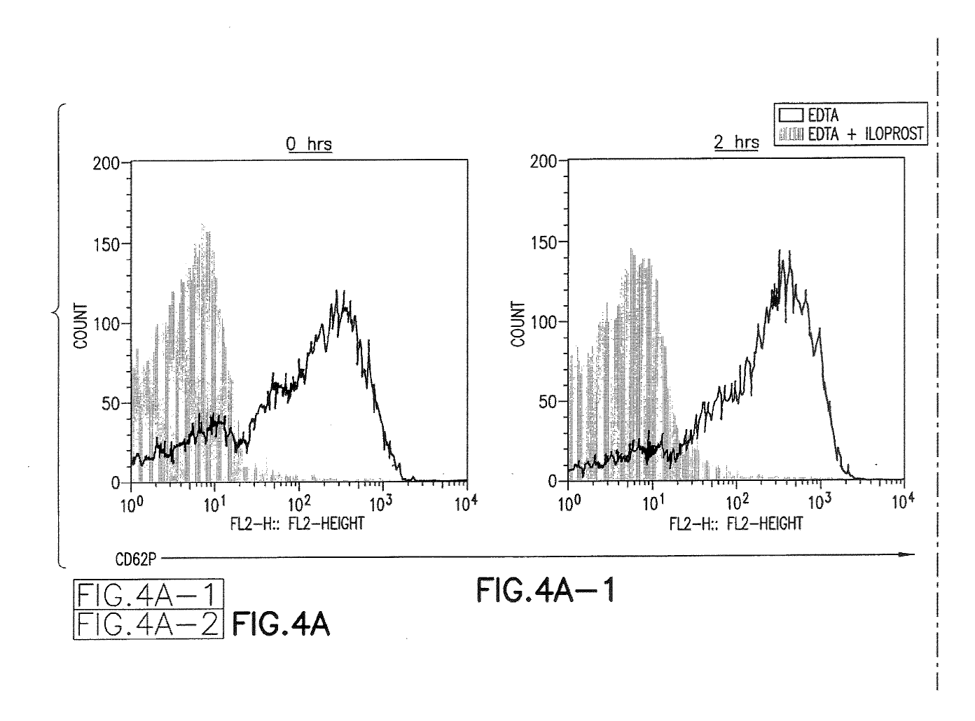

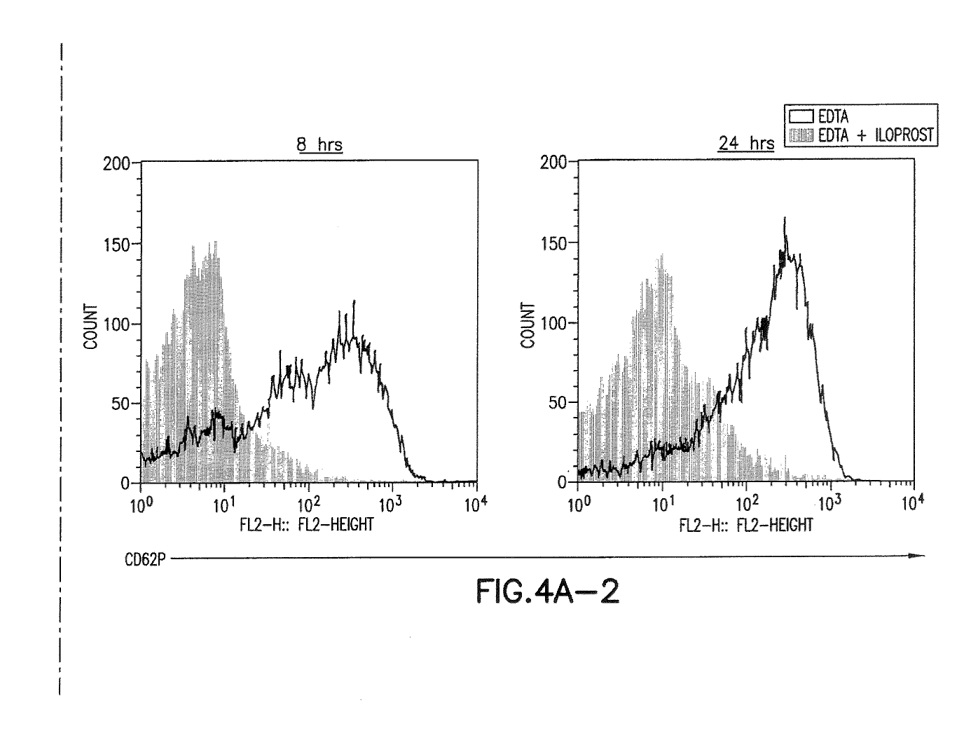

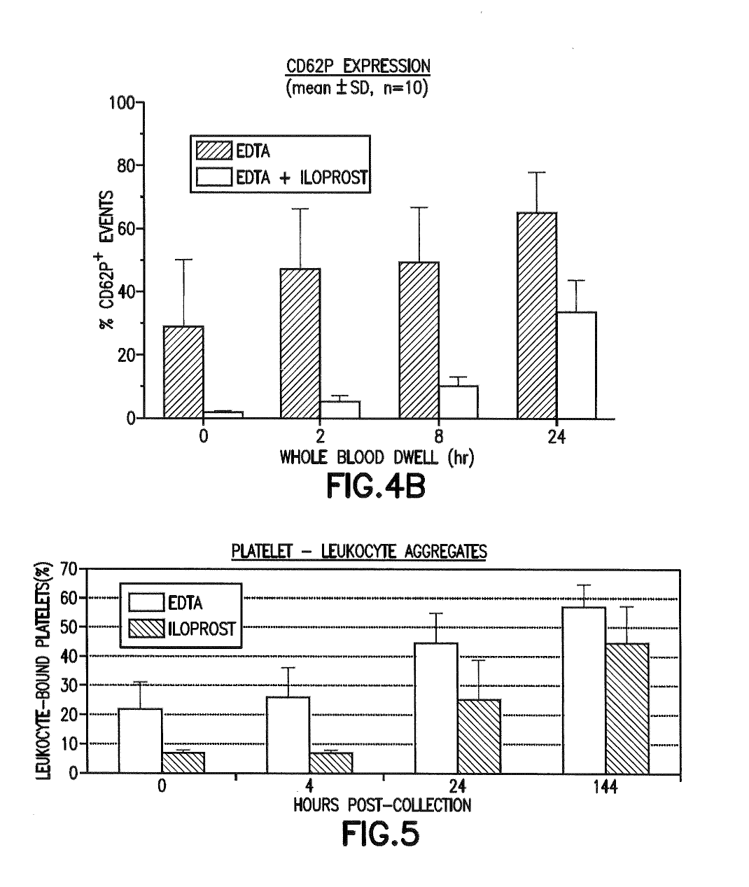

As shown in FIG. 4A, expression of CD62P was analyzed as described in example 1 at t=0, 2, 8 and 24 hr of sample dwell. FIG. 4B shows the percentage of CD62⁺ events for each condition at each timepoint shown as the mean±SD for 10 subjects. The table below shows the median fluorescent intensity for all platelet events at each timepoint for 10 subjects.

| MFI Over Time | 0 hrs | 2 hrs | 8 hrs | 24 hrs |
|---|---|---|---|---|
| EDTA | 20.21 | 42.66 | 33.14 | 63.02 |
| EDTA + Iloprost | 4.08 | 4.49 | 5.13 | 11.25 |

### Example 4

### Iloprost Reduces the Level of Leukocyte-Platelet Aggregates in EDTA

Blood was collected as described in example 1. Antibody cocktails containing previously determined amounts of αCD61 (platelet marker), αCD45 (leukocyte marker) and/or appropriate isotype controls were used to detect the platelet-leukocyte aggregates at t=0, 4, 24 and 144 hr of sample dwell with the use of flow cytometry as described in example 1. As shown in FIG. 5, the percentage of leukocyte-bound platelets at each timepoint was reduced with addition of iloprost. Data representative of 6 subjects.

### Example 5

### Iloprost Reduces Platelet Clumping

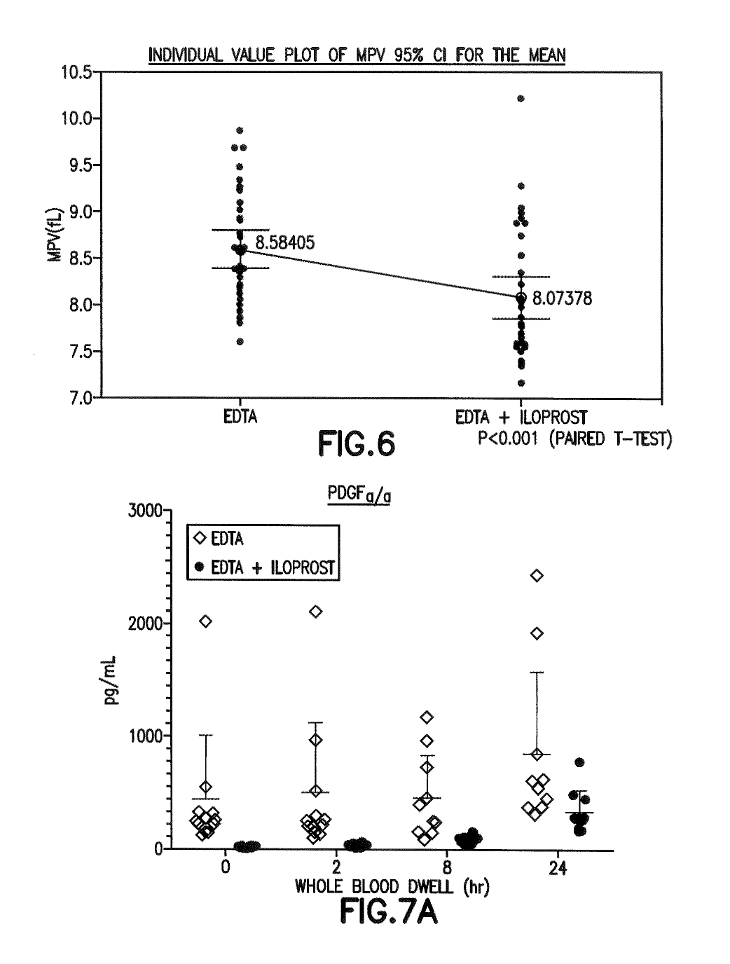

Blood was collected as described in example 1. The complete blood count (CBC+DIFF) and other hematology parameters were measured using Sysmex XE-2100, per manufacturer's instructions. As shown in FIG. 6, there was a lower mean platelet volume (MPV) in the presence of iloprost as compared to EDTA alone (p<0.001, Paired Test). Similarly, lower levels for other platelet-specific parameters, namely PDW and P-LCR, were observed for EDTA/iloprost as compared to EDTA alone (data not shown). As shown in the table below, in the lower panel (B), addition of iloprost was associated with a 40% decrease in platelet clumps as compared to EDTA alone in a study of 300 normal healthy subjects.

| | | | | Total and | |
|---|---|---|---|---|---|
| | | | | Percent | |
| | Total and Percent Platelet | | | Platelet | 95% |
| | Clumps Flags by Site | | | Clumps | confidence |
| | Site 1 | Site 2 | Site 3 | Flags | interval |
| BD Plus K2 | 8/299 = | 6/200 = | 3/196 = | 17/695 = | (1.4%, |
| EDTA | 2.68% | 3% | 1.53% | 2.45% | 3.9%) |
| EDTA/iloprost | 3/150 = | 2/100 = | 0/98 = | 5/348 = | (0.5%, |
| Evaluation | 2.00% | 2% | 0% | 1.44% | 3.3%) |

### Example 6

### Iloprost Inhibits EDTA-Mediated Spontaneous Release of Biomarkers

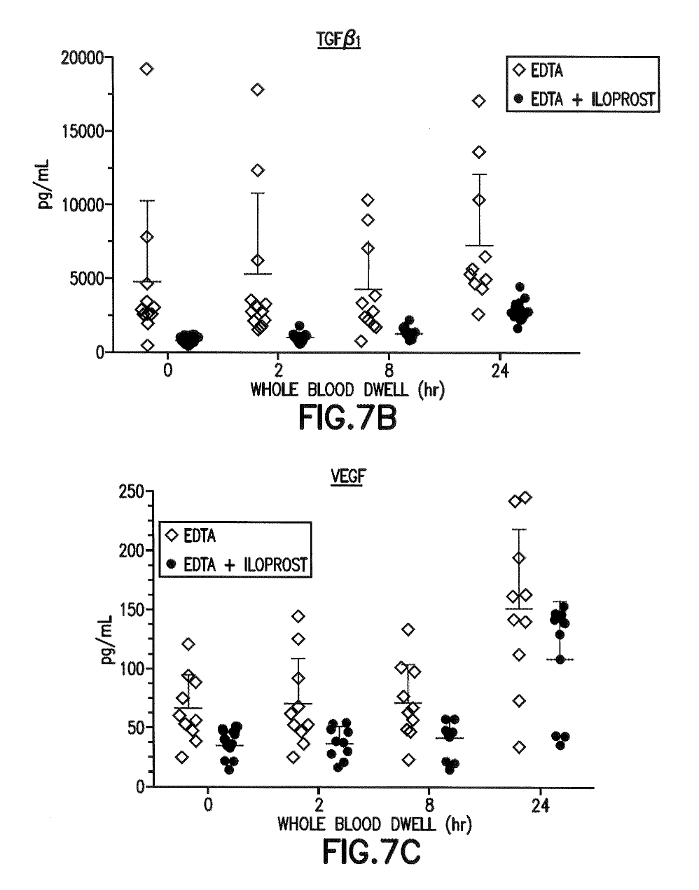

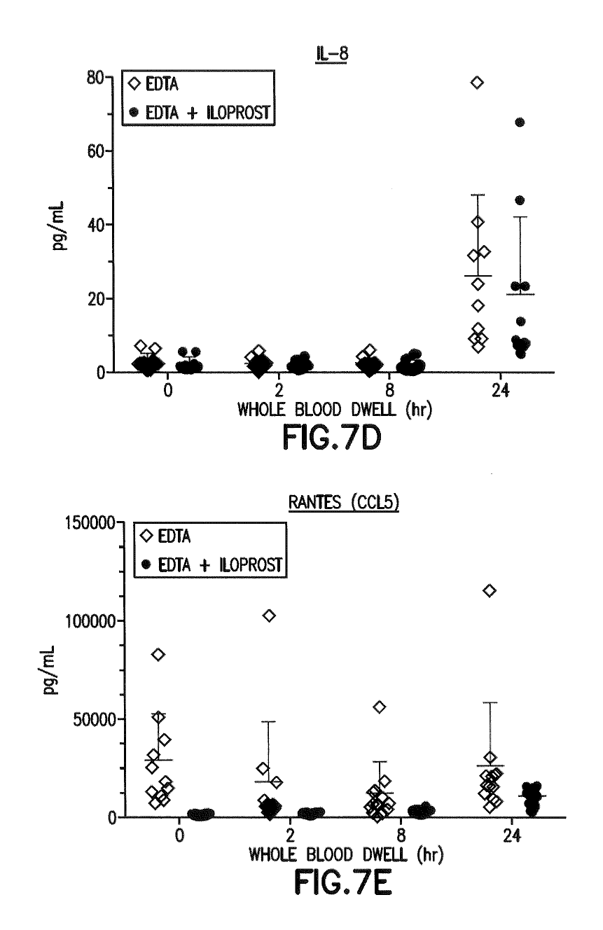

Blood was collected as described in example 1. Plasma was prepared at indicated timepoints (0, 2, 8 and 24 hr sample dwell) by centrifuging the tubes at 3000 rcf for 10 min. and was used to measure levels of PDGF_{a/a}, TGFβ₁, VEGF, IL-8 (CXCL8), and RANTES (CCL5) using commercially available ELISA kits, per manufacturer's instructions. As shown in FIGS. 7A-C and E, Addition of iloprost resulted in reduced expression of PDGF_{a/a}, TGFβ₁, VEGF, RANTES at all timepoints analyzed, relative to EDTA alone (open diamonds). As shown in FIG. 7D, expression of IL-8 was similar between EDTA alone and EDTA with iloprost.

### Example 7

### Iloprost Mitigates Subject Variance Induced by Artificial Activation with EDTA

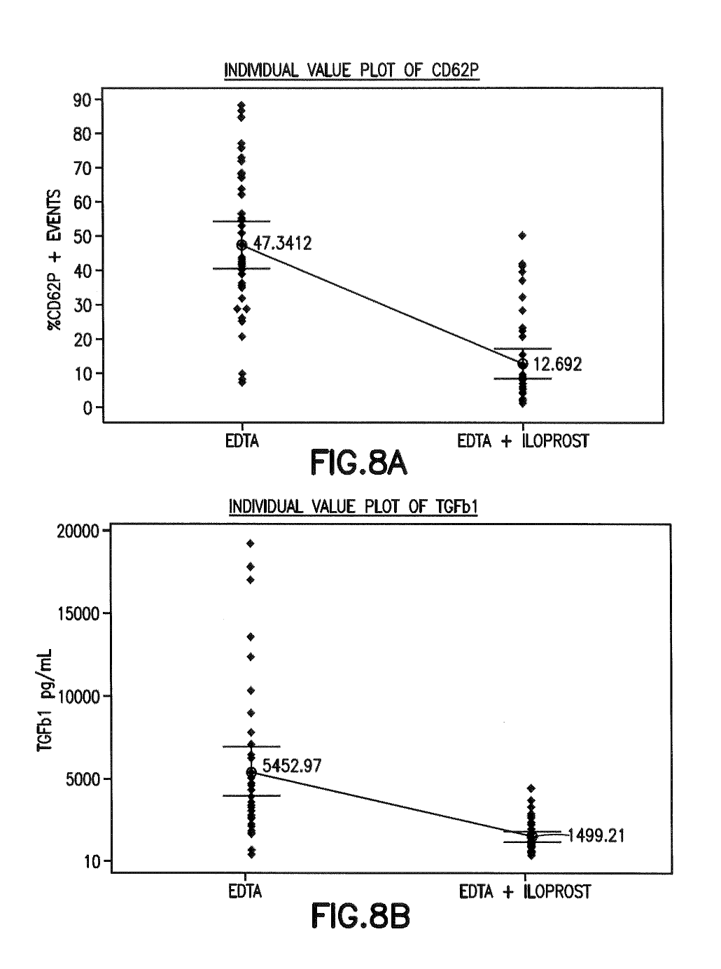

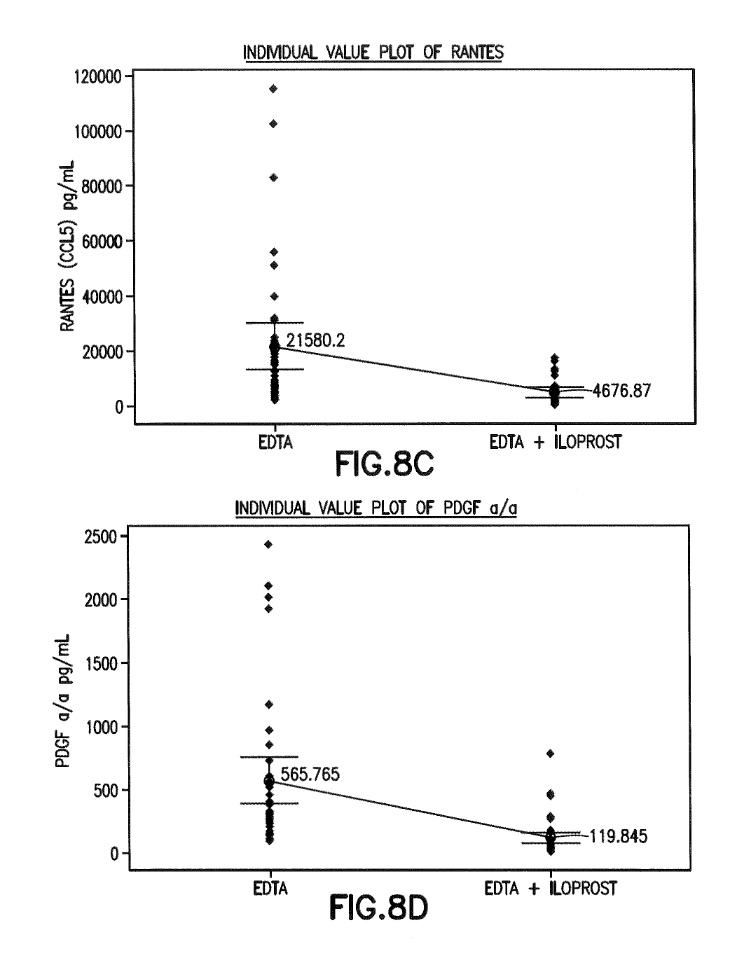

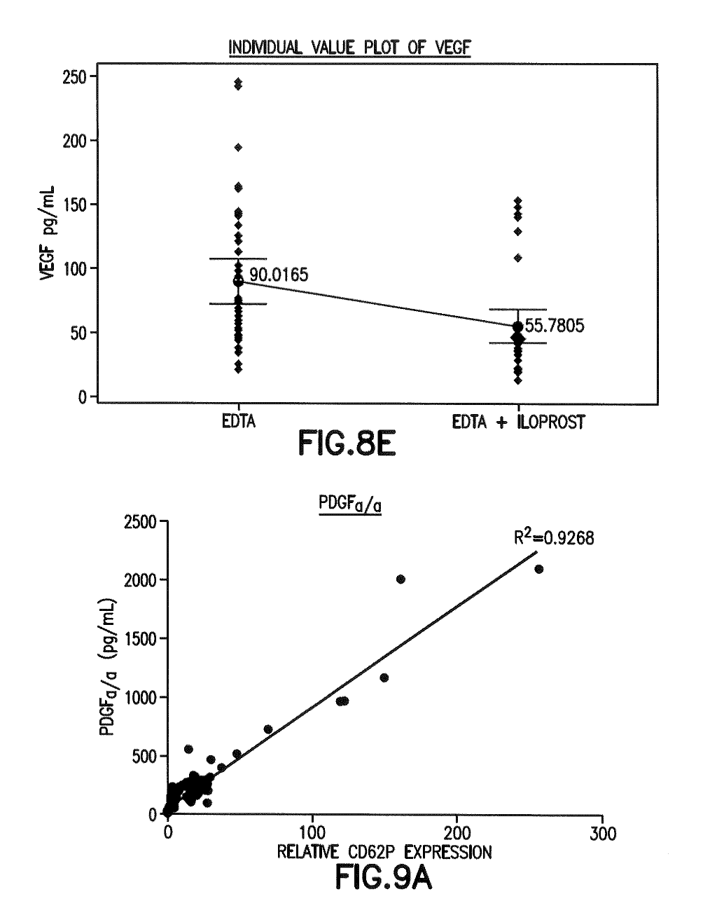

Blood was collected and processed as described in example 3 (for CD62P) and example 6 (for TGFβ₁, RANTES, PDGF_{a/a}, and VEGF). FIGS. 8A-E represent expression of CD62P, TGFβ₁, RANTES, PDGF_{a/a}, and VEGF for EDTA or EDTA/iloprost, as measured in examples 3 and 6, at all timepoints combined. Expression in EDTA alone was significantly higher than expression in EDTA with iloprost (mean expression levels depicted for each factor at each condition). The table below shows that iloprost provided statistically significant reduction in subject variance induced by EDTA out to 24 hr of sample dwell.

| Variance | CD62P | PDGF_{a/a} | TGFβ₁ | VEGF | IL-8 | RANTES |
|---|---|---|---|---|---|---|
| EDTA | 459 | 3.43 × | 2.27 × | 3.12 × | 220 | 6.85 × |
| | | 10⁵ | 10⁷ | 10³ | | 10⁸ |
| EDTA + | 183 | 2.52 × | 9.15 × | 1.67 × | 172 | 2.52 × |
| Iloprost | | 10⁴ | 10⁵ | 10³ | | 10⁷ |
| F-test | 0.005 | 0.000 | 0.000 | 0.054 | 0.447 | 0.000 |

### Example 8

### CD62P is a Good Proxy Marker for Measurement of Platelet-Derived Biomarkers as Demonstrated by Strong Correlation Between Surface Expression of CD62P and Select Factors

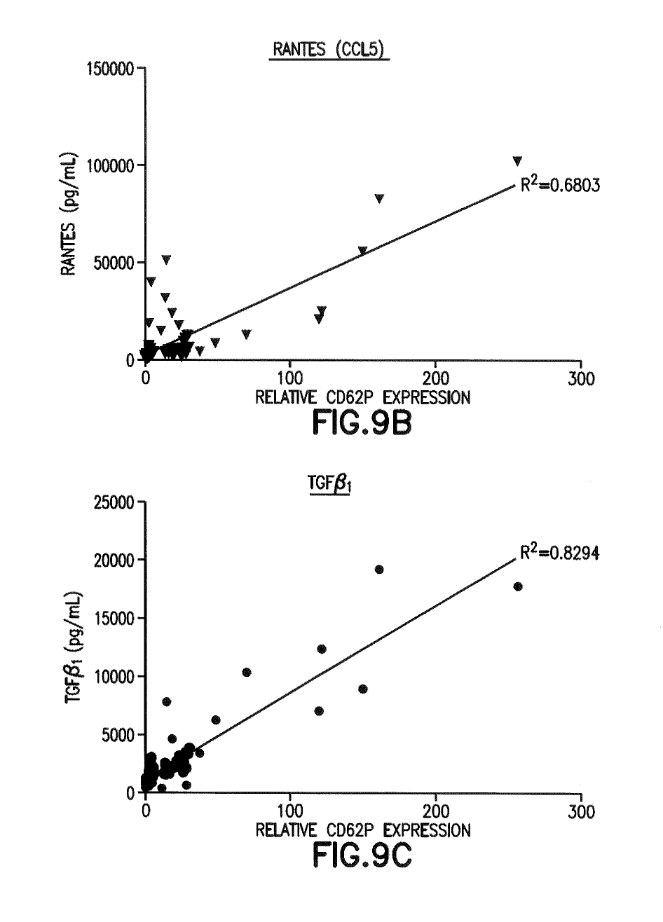

Expression of PDGF_{a/a}, TGFβ₁, VEGF, IL-8, and RANTES (as measured in example 6) was correlated with expression of CD62P (as measured in example 3). As shown in FIGS. 9A and 9C, strong correlation with CD62P was determined for PDGF_{a/a} (R²=0.9268) and TGFβ₁ (R²=0.8294). As shown in FIGS. 9B and 9D, a positive relationship with weak correlation was determined for RANTES (R²=0.6803) and VEGF (R²=0.6051), suggesting that in addition to platelets, other cell types also express these factors. FIG. 9E shows no correlation between CD62P and IL-8 (R²=0.0381), suggesting that expression of IL-8 is platelet-independent.

### Example 10

### Expression of CD62P is Similar Between EDTA and EDTA with Protease Inhibitor Cocktail Both in the Presence and Absence of Iloprost

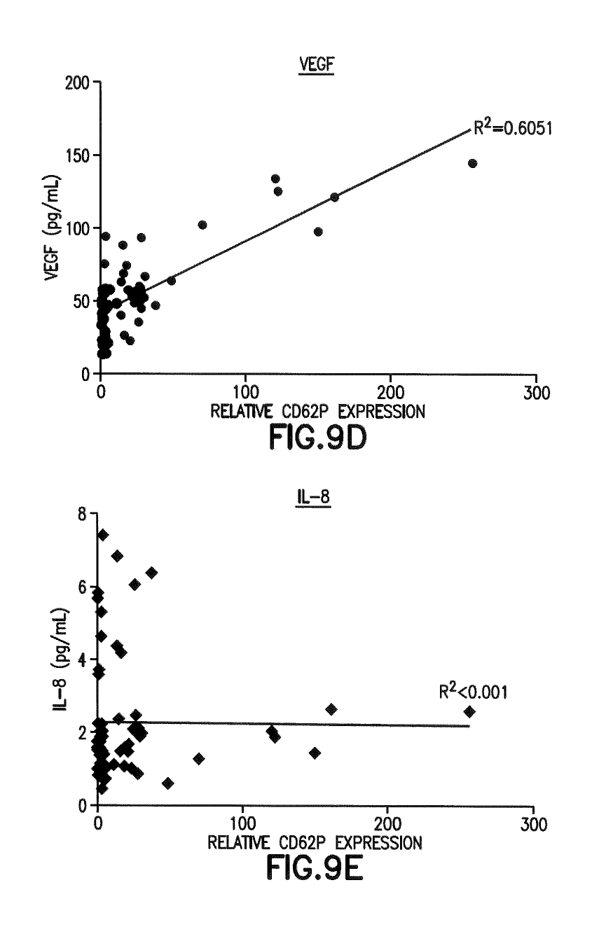

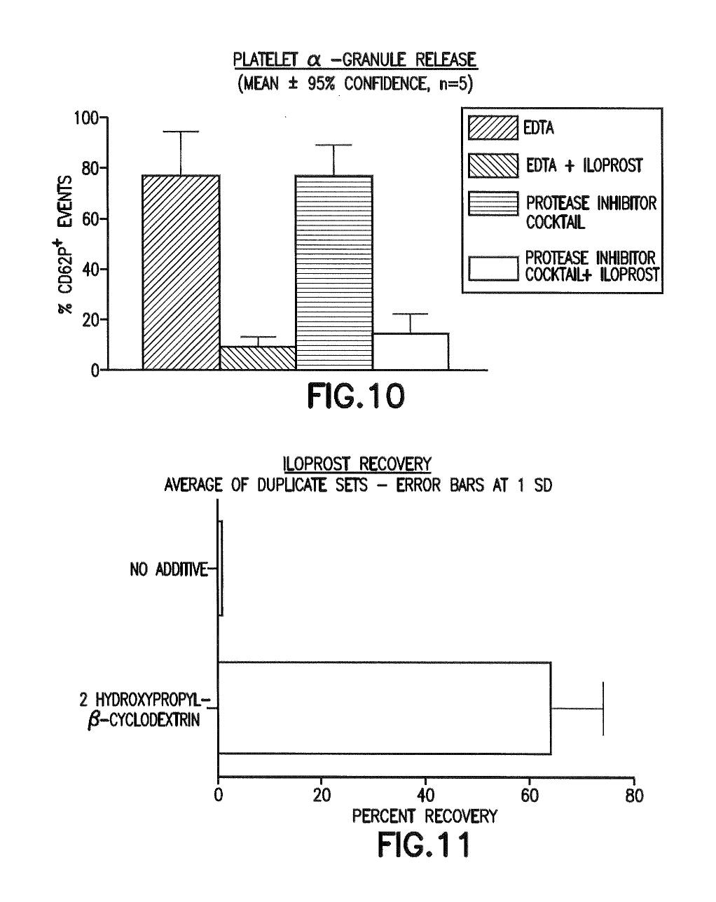

The effect of iloprost on platelet degranulation was measured in EDTA and EDTA/protease inhibitor background. Whole blood was collected into tubes containing EDTA, EDTA with iloprost, a protease inhibitor cocktail (“PIC”, which included one protease inhibitor from each class of inhibitor described in Table II in U.S. Pat. No. 7,309,468), and the cocktail with iloprost. Whole blood flow cytometry to measure CD62P expression was performed as described in example 1. As shown in FIG. 10, the percentage of CD62⁺ events was reduced with the addition of iloprost for both EDTA and PIC backgrounds as shown as the mean±95% confidence for 5 subjects. These results suggest that artificial release of biomarkers in the ETDA/protease inhibitor background will also be inhibited with the addition of iloprost. The table below shows the median fluorescent intensity for all platelet events for 5 subjects.

| Configuration | MFI |
|---|---|
| EDTA | 171.56 |
| EDTA + Iloprost | 5.07 |
| PIC | 146.66 |
| PIC + Iloprost | 5.73 |

### Example 11

### Iloprost recovery is improved in the presence of (2-hydroxypropyl)-β-cyclodextrin

Blood collection tubes were prepared with K₂EDTA (final concentration, 23 mM) and iloprost (final concentration, 7.2 ug/mL). Additionally, the following components were added to the base formulation in the vials: a) no additive, b) (2-hydroxypropyl)-beta-cyclodextrin (final concentration, 0.36 mg/mL or 0.26 mM), c) Tris(hydroxymethyl)aminomethane base (TRIS; final concentration, at 3.6 mg/mL or 30 mM), d) albumin from bovine serum (final concentration, 0.36 mg/mL), and e) combination of (2-hydroxypropyl)-beta-cyclodextrin and albumin. Sample tubes were dried under ambient conditions in a fume hood over a weekend. The contents the individual vials were then extracted with 150 uL of purified water and analyzed by HPLC using an isocratic mobile phase consisting of 48% acetonitrile and 58% 0.02 M potassium phosphate, pH 3.0 on a 3.9×150 mm C-18 reversed phase column run at 1 mL/min. Iloprost was detected by UV absorption at 207 nm. Full recovery of iloprost from samples at 3.84 ug/mL was calculated to give a total absorbance signal of 219 mAU*sec. Recovery of the dried samples was compared with the original liquid stocks of the additives.

As shown in FIG. 11, iloprost was recovered from vials containing (2-hydroxypropyl)-beta-cyclodextrin and, to a lesser extent, from vials containing albumin (data not shown). No iloprost was recovered from the vials containing K₂EDTA alone or K₂EDTA plus TRIS. Among the cyclodextrin additives, (2-hydroxypropyl)-beta-cyclodextrin provided the best recovery of iloprost (data not shown). Iloprost recovery was not affected by gamma irradiation of the tubes (data not shown).

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

All patent publications and non-patent publications are indicative of the level of skill of those skilled in the art to which this invention pertains. All these publications are herein incorporated by reference to the same extent as if each individual publication were specifically and individually indicated as being incorporated by reference.

1. A device for collecting and stabilizing blood or plasma, comprising a first end and a second end and at least one interior wall defining a reservoir portion for receiving whole blood or plasma, and which comprises an anticoagulant, an antiplatelet agent comprising a prostaglandin, a phosphodiesterase inhibitor, a cyclooxygenase inhibitor, or a combination or two or more thereof, and a solubilization agent, wherein the anticoagulant and the antiplatelet agent are each present in an amount to stabilize the blood or plasma.

2. The device of claim 1, wherein the anticoagulant is selected from the group consisting of EDTA or a salt thereof, oxalates, citrate, heparin, a combination of citrate, theophylline, adenosine and dipyridamole (CTAD), sodium polyanethol sulfonate, acid citrate dextrose, and combinations of two or more thereof.

3. The device of claim 1, wherein the anticoagulant is present in a concentration of about 1 mM to about 200 mM, relative to volume of the blood or plasma collected into the device.

4. The device of claim 1, wherein the antiplatelet agent is a prostaglandin.

5. The device of claim 4, wherein the prostaglandin comprises prostaglandin E1, prostaglandin E2 or a combination thereof.

6. The device of claim 1, wherein the prostacyclin comprises carbaprostacyclin, beraprost, iloprost, 5,6-dihydroprostacyclin, ciprostene, limaprost, 13,14-dehydro-15-cyclohexyl carbaprostacyclin, taprostene, and or a combination of two or more thereof.

7. The device of claim 1, wherein the antiplatelet agent comprises iloprost.

8. The device of claim 1, wherein the antiplatelet agent is present in a concentration of about 1×10⁻¹⁰ to about 1×10⁻¹ M, relative to volume of the blood or plasma collected into the device.

9. The device of claim 1, wherein the antiplatelet agent is present in a concentration of about 1×10⁻⁷ to about 1×10⁻⁵ M, relative to volume of the blood or plasma collected into the device.

10. The device of claim 1, wherein the phosphodiesterase inhibitor is selected from the group consisting of MEP-1, Milrinone, Cilostamine, Dipyridamole, Zaprinast and IBMX, and combinations of two or more thereof.

11. The device of claim 1, wherein the cyclooxygenase inhibitor is a non-steroidal anti-inflammatory agent.

12. The device of claim 10, wherein the non-steroidal anti-inflammatory agent is selected from the group consisting of aspirin, indomethacin, ibuprofen, naproxen, meloxicam, diclofenac, piroxicam, tenoxicam, tenidap, and combinations of two or more thereof.

13. The device of claim 1, wherein the solubilizing agent is selected from the group consisting of polyethylene glycol (PEG), monomethoxypolyethyleneglycol (MPEG), PEG lipids, albumin, bovine serum albumin (BSA), and cyclodextrins.

14. The device of claim 13, wherein the solubilization agent is a cyclodextrin.

15. The device of claim 14, wherein the cyclodextrin is 2-hydroxypropyl-β-cyclodextrin.

16. The device of claim 1, wherein the anticoagulant, the antiplatelet agent, and the solubilization agent are disposed in the reservoir of the device.

17. The device of claim 1, wherein the anticoagulant is disposed on at least a portion of the interior wall of the device.

18. The device of claim 1, wherein the anticoagulant, the antiplatelet agent, and the solubilization agent are disposed in the device by spray application or in powdered, crystallized, lyophilized or liquid form.

19. The device of claim 1, further comprising a protease inhibitor or a mixture of one or more protease inhibitors

20. The device of claim 1, wherein the interior wall comprises plastic or glass.

21. The device of claim 1, further comprising a separating element.

22. The device of claim 21, wherein the separating element comprises a thixotropic gel composition.

23. The device of claim 21, wherein the separating element comprises a mechanical separating element.

24. The device of claim 1, further comprising collected blood or a platelet-containing portion thereof.

25. The device of claim 1, which is at least partially evacuated.

26. The device of claim 1, which has been sterilized.

27. The device of claim 1, which is a tube.

28. The device of claim 27, which is a capillary collection tube.

29. The device of claim 27, wherein the anticoagulant is EDTA, dipotassium salt, the antiplatelet agent is iloprost, and the solubilization agent is 2-hydroxypropyl-β-cyclodextrin.

30. The device of claim 29, further comprising a protease inhibitor.

31. The device of claim 30, wherein the protease inhibitor comprises a serine protease inhibitor and an inhibitor of a different class of protease.

32. The device of claim 1 or 30, further comprising an esterase inhibitor.

33. The device of claim 31, further comprising a cocktail of two or more protease inhibitors, wherein the cocktail is selected from the group consisting of: a) an inhibitor of a serine protease and an inhibitor of an exopeptidase; b) an inhibitor of a serine protease and an inhibitor of a cysteine protease; c) an inhibitor of a serine protease and an inhibitor of a dipeptidyl peptidase; d) an inhibitor of a serine protease, an inhibitor of an exopeptidase, an inhibitor of a dipeptidyl peptidase and an inhibitor of a cysteine peptidase; and e) an inhibitor of a serine protease, an inhibitor of an exopeptidase and an inhibitor of a dipeptidyl peptidase.

34. Method of stabilizing blood or plasma during storage, comprising collecting whole blood or plasma into a device comprising a first end and a second end and at least one interior wall defining a reservoir portion for receiving whole blood or plasma, and which comprises an anticoagulant and an antiplatelet agent comprising a prostaglandin, a prostacyclin, a phosphodiesterase inhibitor, a cyclooxygenase inhibitor, or a combination of two or more thereof, and a solubilization agent, wherein the anticoagulant and the antiplatelet agent are each present in an amount to stabilize the blood or plasma.

35. The method of claim 34, wherein the blood or plasma is collected directly into the device.

36. A method of measuring a parameter of blood or plasma, comprising a) collecting whole blood or plasma into a device, comprising a first end and a second end and at least one interior wall defining a reservoir portion for receiving whole blood or plasma, and which comprises an anticoagulant and an antiplatelet agent comprising a prostaglandin, a prostacyclin, a phosphodiesterase inhibitor, a cyclooxygenase inhibitor, or a combination of two or more thereof, and a solubilization agent, wherein the anticoagulant and the antiplatelet agent are each present in an amount to stabilize the blood or plasma; and b) measuring the blood parameter at a predetermined time subsequent to the collecting, and correlating the measured blood parameter to a control.

37. The method of claim 36, wherein the blood parameter is a blood cell count.

38. The method of claim 36, wherein the blood parameter is presence or amount of a biomarker for a disease or pathological condition.
